(19) United States
(12) Patent Application Publication
(10) Pub. No.: US 2026/0220293 A1
(43) Pub. Date: Jul. 30, 2026

(54) SYSTEMS AND METHODS FOR WORKLOAD IDENTITY AND ACCESS MANAGEMENT

(71) Applicant: Aembit, Inc., Silver Spring, MD (US)

(72) Inventors: David GOLDSCHLAG, Silver Spring, MD (US); Kevin SAPP, Silver Spring, MD (US); Victor RONIN, Silver Spring, MD (US); David WALKER, Silver Spring, MD (US)

(21) Appl. No.: 19/629,891

(22) Filed: Mar. 26, 2026

Related U.S. Application Data
(63) Continuation of application No. PCT/US2024/048662, filed on Sep. 26, 2024.
(60) Provisional application No. 63/541,707, filed on Sep. 29, 2023.

(51) Int. Cl. G06F 21/62; H04L 9/08; H04L 9/30; H04L 9/32

(52) U.S. Cl. CPC G06F 21/6218; H04L 9/0825; H04L 9/30; H04L 9/3213; H04L 9/3247; G06F 2221/2141

(57) ABSTRACT

Described are methods and systems for workload identity and access management. The method comprises: receiving a request from a client workload to access a service workload; authenticating the client workload based at least in part on identifying information determined from a compute environment of the client workload; retrieving an access policy based at least in part on the client workload identity; generating or retrieving an access credential to access the service workload based at least in part on the access policy; and communicating data between the workload and the service based at least in part on the access credential.

### CROSS-REFERENCE

This application is a continuation of International Patent Application No. PCT/US 2024/048662, filed on Sep. 26, 2024, which claims priority to U.S. Provisional Application No. 63/541,707 filed on Sep. 29, 2023, each of which is incorporated by reference herein in its entirety.

### BACKGROUND

Modern applications are highly distributed, with workloads (e.g., applications or microservices) leveraging many different resources to source data and delegate operations. For example, an organization might be using services from multiple clouds and databases that are distributed in multiple locations, a set of application programming interfaces (application programming interfaces) from the organization's own applications and/or 3rd party application programming interfaces and/or other services, software-as-a-service (Saas) applications, and more. Often a new data connection is made between the organization's computing resources or applications to third party applications.

### SUMMARY

Identity and access management (IAM) is a framework of business processes, policies, and technologies that facilitates the management of electronic or digital identities and access policies. With an IAM framework in place, information technology (IT) managers or administrators can control user access to critical information within their organizations. Systems used for IAM include single sign-on systems, two-factor authentication, multifactor authentication, and privileged access management. These technologies also provide the ability to securely store identity and profile data as well as data governance functions to ensure that only services and data that are necessary and relevant are shared. However, existing methods and systems for IAM, particularly for workload-to-workload access, have various drawbacks. These drawbacks include being unable to work across different cloud networks, not supporting access to 3rd party application programming interfaces and SaaS services and databases, data lakes, and data warehouses, or requiring many person-hours to develop. Furthermore, service accounts associated with software workloads, both administrators and client workloads logging into user accounts, and long-lived username and password credentials often manually managed and stored on individual machines pose additional security risks and inefficiencies.

Today enterprises manage access between users and services using user IAM systems. These systems, such as Okta IAM or Microsoft Entra ID, give enterprises strong control over user access through centralized policy management, strong user auth, conditional access, issuance of short lived access credentials, and logging. IAM systems provide the platform for enforcing least privilege and Zero Trust access. By only authorizing user access to services via the IAM system, enterprises get comprehensive visibility and control over user access. This improves security, reduces risk, improves the ability to respond to issues, and improves operations. An example flow for user IAM is: The user authenticates to the IAM using a username and password and one-time token multi-factor authentication, MFA). The IAM verifies the identity of the user, and checks an access policy and conditional access, and then returns a short-lived access credential (such as a Security Assertion Markup Language (SAML) token) to the user (e.g., to the user's browser). The user's browser then uses that SAML token to log into the service.

Although user access can be managed through IAM, non-human access is generally managed in more ad-hoc ways. Such non-human entities are referred to as workloads, or software workloads. For instance, a client workload accesses a service workload, but unlike users, the same workload may be both a client and a service depending on the direction that access is initiated. These workloads can be of multiple types, including, but not limited to, in a cloud (e.g., AWS, Azure or Google GCP) or in a datacenter. Such workloads may be of a variety of types, including custom or pre-packaged software, and may be deployed as virtual machines (VMs), Kubernetes containers, or Serverless functions. The workloads may also be SaaS services (e.g., Snowflake or Salesforce or GitHub) or other Cloud APIs, or robotic functions. The term “client workload” as utilized herein may generally refer to an application/service or the alike that requests access to resources. The term “service workload” as utilized herein may generally refer to the resource the client workload is accessing.

Currently, non-human access or workload access flow may require client workloads to log into “service accounts” at service workloads. Service accounts are just like user accounts, but they are generally associated with software workloads instead of people. In some cases, admins may log into service accounts, and client workload may log into user accounts. However, such access flow for non-human (NH) access is not managed like user access. For example, the access credential for a service account is often a long-lived username and password (i.e., a long-lived secret) instead of a short-lived credential. Instead of being centrally managed, this access credential may be manually copied and pasted and learned by admins and stored on their machines. If the access credential is stored in a secrets manager or vault, it is still a long-lived credential and must be periodically rotated and synchronized with the service account. A Client workload needs an identity credential to authenticate to the vault, this identity credential is also a long-lived secret like a certificate (i.e., the private key for a certificate). The client workload is required to store this secret, and also needs to be able to acquire this secret when it first runs (this is called the bootstrap or secret( ) problem). In addition to these long-lived secrets, current workload access approaches have no notion of MFA or of conditional access.

Disclosed herein are systems and methods of managing workload identity and access to securely allow an organization's workloads to access any of the services, databases, applications, or application programming interfaces they need. The proposed method signifies an improvement over the current state by introducing a systematic approach to managing non-human access or workload access. In contrast to the often long-lived, manually managed credentials used today, the method implements short-lived credentials and central management of access, enhancing security and operational efficiency. In some embodiments, the management is based on an identity rather than secrets, to advantageously provide simple, secure, and centralized policy-based access, instead of managing low-level secrets.

Unlike conventional methods requiring identity credentials, methods and systems herein may be capable of cryptographically authenticating client workloads without requiring an identity credential. The methods and systems herein may further provide Multi-Factor Authentication (MFA)-like security level through conditional access such that the health, posture, and context of a client workload is checked before granting access. This beneficially allows for creation of a policy wall between administrators and credentials such that admins are allowed to manage access through policy without requirement of obtaining access credentials.

Implementing the systems and methods disclosed herein provides several advantages. For example, the disclosed systems and methods can help increase security. Furthermore, the disclosed systems and methods can help prevent credential loss and defend from credential exposure, unauthorized access, lack of key rotation, and misconfigured authorization that could cost substantial amounts of money and time. Also, the disclosed systems and methods can help reduce the burden and save time for DevOps and security teams who may otherwise spend substantial amounts of time on workload-to-workload or (workload-to-service) access security and tools. The organization can spend less time on developing and improving security infrastructure and instead more time on helping deliver products and services that the organization is delivering to its customers. Another advantage is that since the disclosed technology manages service access dynamically for client workloads, there is no manual management of secrets and keys and reduced vulnerability for the leakage and compromise of those secrets and keys. Furthermore, access between client workloads and target services can be managed by policy, instead of by sharing secrets. The system can authenticate a client workload without secrets, based on attestation from the client workload's environment and can support such identification across heterogeneous environments. Furthermore, the system can make access decisions based on client workload and the target service, as well as conditional access decisions about the posture of the client workload. The system can broker between diverse environments to map the client workload's identity to deliver credentials for the right account or rights to the service. And the system can support multiple services in multiple environments and multiple credentials for those services. The system can also log all access and access attempts. In some embodiments, the system requires no code changes from developers and therefore can support custom and packaged applications unchanged. And the system operates in the control plane while access between the client workload and services occurs directly. The system can also provide a simple and no-code migration path from long-lived access credentials to short-lived access tokens.

In an aspect, disclosed herein a method of securing access between workloads, comprising: receiving a request from a client workload to access a service workload; authenticating the client workload based at least in part on identifying information determined from a compute environment of the client workload; retrieving an access policy based at least in part on the client workload identity; generating or retrieving an access credential to access the service workload based at least in part on the access policy; and communicating data between the workload and the service based at least in part on the access credential.

In some embodiments, the method comprises logging access events in a database. In some embodiments, the method comprises authenticating the identity of the client workload comprises using a federated approach to interface with the client workload's environment.

In some embodiments, the authenticating the identity of the client workload comprises: receiving an authentication token comprising the identifying information that is signed by a private key that is associated with the compute environment; verifying the authentication token using a public key that is associated with the private key; and providing a signal indicating that the client workload has been verified after the authentication token has been verified. In some embodiments, the retrieving the access policy comprises determining a match between the attestation token and information about the service workload. In some embodiments, the access policy allows group type policies through regular expression matching on a namespace. In some embodiments, the access policy is retrieved from a centralized policy database managed by an identity and access management system. In some embodiments, the access credential is a short-lived token. In some embodiments, the method comprises generating the access credential as a minted token through a trust relationship between the service workload and a federated system. In some embodiments, the minted token corresponds to a service account or a role, or includes claims specifying the client workload's rights at the service. In some embodiments, the access credential is obtained from software as a service (SaaS) service being accessed, configured to trust requests from a federated system and return tokens for access. In some embodiments, the method comprises requesting tokens from federated cloud services for access to services within a cloud, with the cloud services configured to trust requests from the federated system.

In some embodiments, the long-lived credentials like username, passwords, and application programming interface keys are supported, which are either stored within a federated system or requested from a secrets manager specified by the enterprise. In some embodiments, the method comprises implementing a two-sided federation architecture comprising trust relationships for trust providers and credential providers between a federated system, a compute environment, and a service workload or a cloud's federation service. In some embodiments, the two-sided federation architecture aids in generation or retrieval of the access credential. In some embodiments, the access credential is delivered just-in-time to the client workload upon satisfaction of the access policy, providing timely access. In some embodiments, the method comprises providing conditional access based on policies that impose conditions beyond verification of correct client workload accessing correct service. In some embodiments, the conditional access comprises confirming a posture or configuration of the client workload by querying external risk assessment entities like CrowdStrike Falcon or Wiz for risk information, using the workload identity. In some embodiments, the conditional access depends on information from the client workload, such as an IP address of the client workload. In some embodiments, the conditional access is contextual, including time of day restrictions on access policies, geographic restrictions, or both. In some embodiments, the conditional access policies serve as multi-factor authentication (MFA) for workload, to enhance a cryptographic identity in making an access decision. In some embodiments, a context of conditional access policies hardens the authentication, such that a service account token delivered from an untrusted environment will not be trusted. In some embodiments, some access conditions may be embedded in an access credential, allowing the service to enforce a downstream conditional access check. In some embodiments, the access credential is augmented with a conditional access policy about IP addresses, so the access credential can only be used by clients in specified IP address ranges, preventing misuse of the access credential by rogue clients outside of the expected environment.

In another aspect, disclosed herein are methods for managing access between workloads, comprising: (a) intercepting, by an edge component, a client workload and sending an attestation token about an identity of the client workload and information about a service workload that the client workload is to access to a cloud component; (b) receiving, by the cloud component, the attestation token and generating an access credential based at least in part on the attestation token and an access policy; and (c) injecting, by the edge component, the access credential to the client workload.

In some embodiments, the attestation token is for authenticating then identity of the client workload. In some embodiments, the attestation token is generated based on an identifying information that is signed by a private key that is associated with a compute environment of the client workload. In some embodiments, the cloud component verifies the attestation token using a public key that is associated with the private key. In some embodiments, the cloud component further verifies the attestation token by validating additional fields of the attestation token for enhanced security. In some embodiments, the access credential is a short-lived token. In some embodiments, the method comprises determining a match between the attestation token and information about the service workload. In some embodiments, the access policy comprises conditional access policy. In some embodiments, the conditional access policy comprises factors related to the health and posture of the client workload, and the geographic location or time of an access request.

In yet another aspect, disclosed herein are systems for managing access between workloads, comprising: an edge component configured to: (i) intercept a client workload; (ii) send an attestation token about an identity of the client workload and information about a service workload that the client workload is to access to a cloud component; and the cloud component configured to: (i) receive the attestation token; (ii) generate an access credential based at least in part on the attestation token and an access policy; (iii) and send the access credential to the edge component for injecting into the client workload. In some embodiments, the attestation token is for authenticating then identity of the client workload. In some embodiments, the attestation token is generated based on an identifying information that is signed by a private key that is associated with a compute environment of the client workload. In some embodiments, the cloud component is configured to further verify the attestation token using a public key that is associated with the private key. In some embodiments, the cloud component is configured to further verify the attestation token by validating additional fields of the attestation token for enhanced security. In some embodiments, the access credential is a short-lived token. In some embodiments, the cloud component is configured to further determine a match between the attestation token and information about the service workload. In some embodiments, the access policy comprises conditional access policy. In some embodiments, the conditional access policy comprises factors related to the health and posture of the client workload, and the geographic location or time of an access request.

Another aspect includes a non-transitory computer-readable media comprising executable instructions that, when executed, cause at least one computer processor to perform any of the methods described herein.

Another aspect is a computer system comprising a memory storing computer-readable instructions and at least one processor configured to execute the computer-readable instructions that are configured to perform the method of any of the methods described herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of an architecture of an environment for providing workload identity and access management, in accordance with some embodiments.

FIG. 2 shows an example of a workflow of implementing the workload identity and access management, in accordance with some embodiments.

FIGS. 3, 4, 5, 6, 7, 8, 9, 10, 11, 12, 13, 14, 15, 16, 17, and 18 show example screenshots of a user interface of the workload identity and access management console, in accordance with some embodiments.

FIG. 19 shows an example of a computer system that is programmed or otherwise configured to implement workload identity and access management, in accordance with some embodiments.

FIG. 20 shows an example of a system that handles the identity and access of various workloads in a distributed application environment, in accordance with some embodiments.

FIG. 21 shows an example of a system configured to manage the identity and access of encapsulated software units, or ‘containers’, within a distributed application context, in accordance with some embodiments.

FIG. 22 shows an example of a system architecture for a Workload Identity Broker.

FIG. 23 shows another example of system architecture credential providers, in accordance with some embodiments.

FIG. 24 shows an example of the system architecture trust providers, in accordance with some embodiments.

FIG. 25 shows a detailed view of a system architecture conditional access functionality, in accordance with some embodiments.

FIG. 26A shows an example of the functionality of the system cloud, in accordance with some embodiments.

FIG. 26B shows an example of the method of application programming interface Integration, in accordance with some embodiments.

FIG. 27 shows various use cases of the Workload Identity and Access Management System, in accordance with some embodiments.

FIG. 28A presents an example of a scenario prior to implementing the workload identity and access management system, in accordance with some embodiments.

FIG. 28B shows an example of improved in the access management process following the implementation of the workload identity and access management system, in accordance with some embodiments.

FIG. 29A shows the traditional method for accessing secure storage systems prior to the implementation of the identity and access management system, in accordance with some embodiments.

FIG. 29B shows a method for accessing secure storage systems after the implementation of the advanced Identity and Access Management (IAM) system, in accordance with some embodiments.

FIG. 30A shows an example of the state of interactions between GitLab and third-party services prior to the deployment of the workload identity and access management system, in accordance with some embodiments.

FIG. 30B shows an example of the improved state of interactions between GitLab and third-party services following the deployment of the workload identity and access management system, in accordance with some embodiments.

FIG. 31A shows an example of managing access to logs prior to the deployment of the workload identity and access management system, in accordance with some embodiments.

FIG. 31B shows an example of an enhanced scenario for log access management following the deployment of the workload identity and access management system, in accordance with some embodiments.

FIG. 32A shows an example of the state of workload enrollment prior to the implementation of the workload identity and access management system, in accordance with some embodiments.

FIG. 32B shows an example of the improved process for workload enrollment after implementing the Workload Identity and Access Management System, in accordance with some embodiments.

FIG. 33A shows an example of the employment of a popular Identity and Access Management (IAM) tool in a user IAM scenario prior to the deployment of the workload identity and access management system, in accordance with some embodiments.

FIG. 33B shows an example of the improved process for managing workload access within the context of the implemented Workload Identity and Access Management System, in accordance with some embodiments.

FIG. 34 shows the system architecture that functions as a Universal Workload Identity Provider, in accordance with some embodiments.

FIG. 35 shows an example of the credential providers in the system, in accordance with some embodiments.

FIG. 36 shows an in-depth illustration of the role and operation of trust providers, in accordance with some embodiments.

FIG. 37 shows a workflow where the IAM system grants conditional access, in accordance with some embodiments.

FIG. 38 shows the overarching vision and use cases for the system, presenting it as the Control Plane to Secure Access between Workloads Everywhere, in accordance with some embodiments.

FIG. 39 shows a method to securely manage access between workloads and services, in accordance with some embodiments.

FIG. 40 provides a comprehensive view of the system managing access between various workloads and services, in accordance with some embodiments.

FIG. 41 shows the role of trust providers within the system, in accordance with some embodiments.

FIG. 42 shows an example of system architecture which acts as a Universal Workload Identity Broker, in accordance with some embodiments.

### DETAILED DESCRIPTION

While various embodiments have been shown and described herein, it will be obvious to those skilled in the art that such embodiments are provided by way of example only. Numerous variations, changes, and substitutions may occur to those skilled in the art without departing from the present disclosure. It should be understood that various alternatives to the embodiments described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an improved, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

### Overview

Modern applications are highly distributed, with workloads such as applications or microservices leveraging many different resources to source data and delegate operations. For example, an organization (e.g., a company, enterprise, etc.) might be using services from multiple clouds and databases that are distributed in multiple locations, a set of application programming interfaces (application programming interfaces) from the organization's own applications and/or 3rd party application programming interfaces and/or other services, software-as-a-service (Saas) applications, and more. Often a new data connection is made between the organization's computing resources or applications to third party applications. There is an increasing attack surface or vulnerability with every new connection that the organization's application(s) makes. Operational complexity is increasing for teams to manage it all, and regular audits or credential rotations (e.g., changing passwords every 3 months, etc.) can become major projects. And secrets, the method used to connect applications today, are sprawled across applications whether they are hardcoded or managed on a team-by-team basis.

Identity and access management (IAM) includes a framework of business processes, policies and technologies that facilitates the management of electronic or digital identities. With a user IAM framework in place, information technology (IT) managers can control user access to critical information within their organizations. Systems used for IAM include single sign-on systems, two-factor authentication, multifactor authentication, and privileged access management. These technologies also provide the ability to securely store identity and profile data as well as data governance functions to ensure that only data that is necessary and relevant is shared.

Management and access for workload-to-workload (or workload-to-service) connections may typically be performed in one of three ways: a cloud IAM, vaults, and custom methods. A cloud IAM is a framework where administrators grant individual users or workloads access to cloud resources. Cloud IAM works well for controlling access to native services at a single cloud-provider, but breaks down once an organization begins crossing boundaries into other clouds and multiple cloud networks need to access one another, e.g., SaaS services, or even into the organization's own on-premises software. Vaults are good for secrets (e.g., passwords), but assumes that the vault system can determine the identity of the client requesting access. Further, they typically require active maintenance from IT administrators and development teams to integrate into the organization's application and infrastructure. Lastly, custom applications are most commonly performed today with a set of manual configurations, best practices, and allowlists, but there is much consideration and effort put into making these tools scale well which can still easily fall apart during an incident such as network or connection failures.

Disclosed herein are systems and methods of managing a workload identity and access platform to safely allow an organization's applications to connect to any services, databases, applications, or application programming interfaces of different environments they need. For example, the disclosed technology may configure a workload in a cloud environment from an organization to be able to access a service that is hosted by another organization in another cloud environment (e.g., the two cloud environments do not overlap each other). In some embodiments, the management is based on an identity rather than secrets to advantageously provide a simple, secure, and central way to provide policy-based access, instead of managing low level secrets. In some embodiments, secrets may be automated and dynamically delivered, rather than managed by IT administrators and/or individual users. In some embodiments, access to admin credentials may be removed for workloads. In some embodiments, a problem known as the “secret zero” problem of identity may be resolved for a new device by removing the use of an identity secret. In some embodiments, no-code changes are necessary to the client workload. In some embodiments, conditional access policies may complement access policies for richer access decisions.

In some embodiments, the disclosed technology may be used to manage access to SaaS and 3rd party application programming interfaces in a policy-based manner. In some embodiments, the disclosed technology may be used for secure data lake and database access by providing a policy driven access framework based on workload identity that is consistently applied across legacy and modern environments as well as multiple clouds. In some embodiments, the disclosed technology may configure workload IAM for heterogeneous environments where legacy and modern applications can connect to one another across boundaries with a consistent identity and access management model. For example, an application that was developed by a company and hosted on a cloud environment may access another application developed by another company and hosted on a different cloud environment such as Amazon AWS. In some embodiments, the disclosed technology may be used with zero trust for workloads which allow for conditional access by checking workloads for posture conditions before access.

In some embodiments, the disclosed technology may be implemented as a workload identity provider (IdP) to broker between workload identity and service credentials, using one or more policies to control access. In some embodiments, the disclosed technology may include federation with both the workloads environment to determine the identity of the workload and the service's environment to produce access credentials.

### Workload Identity and Access Management Environment

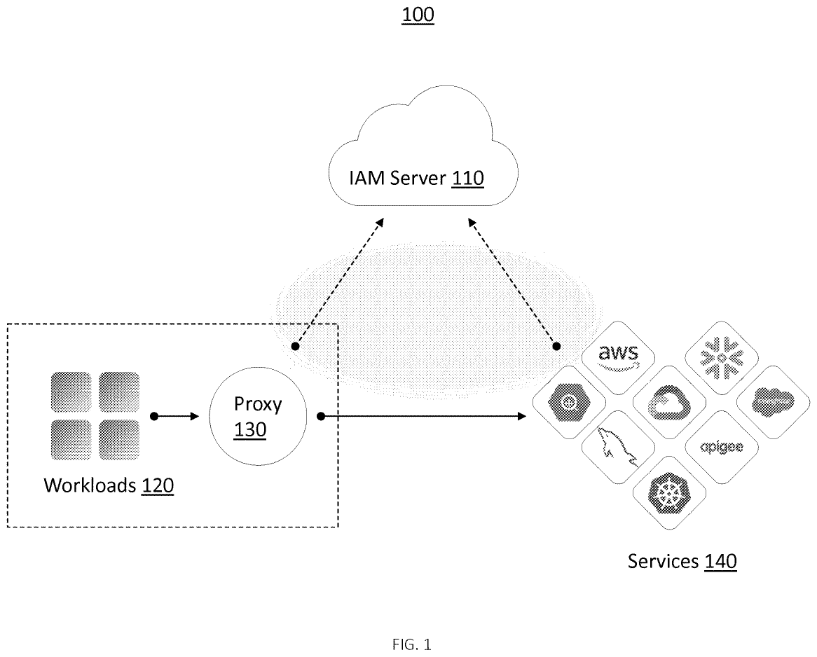

FIG. 1 shows an example of an architecture of an environment 100 for providing workload identity and access management, in accordance with some embodiments. In some embodiments, the environment 100 includes an IAM server 110, one or more workloads 120, one or more proxies 130, and one or more services 140. Although certain entities or elements are shown in FIG. 1, embodiments are not limited thereto, and there can be more or fewer elements without varying from the scope of invention. For example, in some embodiments, the proxy 130 may be omitted, and the workloads 120 may communicate with the IAM server 110 and the services 140 directly. In some embodiments, the workloads 120, the service 110, the proxy 130, and services 140 may communicate with one another via wired or wireless connection(s). In some embodiments, the IAM server 110 and the proxy 130 may be collectively called an IAM system.

In some embodiments, the workloads 120 may include applications or programs including custom code that a user or organization writes or packaged applications that may be run in the organization's environment. In some embodiments, the applications may be run on-prem or in a cloud environment, for example in Kubernetes or in virtual machines (VMs). In some embodiments, workloads may include any application, service, or module that tries to access any application, service, SaaS, or module that requires some kind of access. In some embodiments, the workloads may include any form of software that communicates with other software both within and outside of the organization's computing environment. In some embodiments, a service or target service may include any application or module that the workload is trying to access.

In some embodiments, the access policies between the client software and the service software may be managed by the organization's IT personnel, security team, and/or DevOps team. In some embodiments, an access policy may include a basic policy that states workload A is allowed to access service B. In other embodiments, the access policy may be more abstract and state that a class of workloads may access a class of services. In other embodiments, the access decision may depend on both the identity of the client workload and its posture (e.g., conditional access).

The services 140 may include one or more software services that the organization may access for operation of the organization's business. In some embodiments, the services 140 may include application programming interfaces, SaaS applications, applications run by the organization's business partners, additional cloud services provided by third party services, etc.

In some embodiments, the IAM server 110 may include one or more computer processors or servers that are deployed in a cloud environment and accessible by the workloads 120, proxy 130, and services 140. In some embodiments, the IAM server 110 may provide a centralized service for workload identity and access management, workload access policies, visibility, and logging. In some embodiments, the IAM server 110 may be operated as a SaaS platform. In some embodiments, the IAM server 110 may manage the identity and access for workloads, and in some embodiments, the IAM server may not have access to the data that is run and transferred via the workloads 120. In some embodiments, the IAM server 110 may include or be connected to a database of the access policies.

In some embodiments, the proxy 130 may include a transparent proxy that is deployed alongside each workload for which a user would like to manage its workload identity. In some embodiments, in Kubernetes the proxy 130 may be deployed as a sidecar, and on a VM the proxy 130 may be deployed as an agent. In some embodiments, the proxy 130 may work to validate the identity of the workload and also inject credentials on behalf of the workload. In some embodiments, the proxy 130 may configure access without code changes to the client workload (no-code authentication). For example, instead of modifying the code in their applications, the proxy 130 may intercept access requests, authenticate to the IAM service, and request an access credential, and inject the access credential into validated requests for access. In some embodiments, the proxy 130 can be deployed for existing and new applications within the organization's environment because the proxy 130 can be slotted in and manage credentials without changes to the applications. In some embodiments, the proxy may operate as a standalone virtual appliance. In some embodiments, the proxy 130 may communicate over hypertext transfer protocol (HTTP) or hypertext transfer protocol secure (HTTPS). In some cases, the proxy may be a TCP proxy and inject credentials for Postgress or SQL or other protocols.

In some embodiments, the IAM system or the IAM server may federate with (1) the workload's environment in order to identify and authenticate the workloads and (2) with the service that the workload is trying to access to produce the appropriate credentials. In some embodiments, the IAM system may federate with services 140 through credential providers which allow the IAM system to be trusted by the services to issue credentials that the client workload can use to access the services 140. In some embodiments, the IAM system may federate with the organization's workload environment through trust providers which allow the IAM system to cryptographically validate the workload's identity through attestation. In some embodiments, federation on the service side may include customizing the credential process based on native features of the service so that the service is not modified in order to interact with the proxy and/or the IAM server. For example, the credential provider may generate a credential that the service is expecting. In some embodiments, the service may trust the IAM system to produce or request credentials and the IAM system may trust the workload's environment to verify workload identity.

### Proxy

In some embodiments, the proxy may reside within the client environment and intercept the communication between the workload and the service. In some embodiments, the proxy may communicate with the service on behalf of the workload. In some embodiments, the credentials received by the proxy from the IAM server may be cached at the proxy. In some embodiments, the credentials may have a set expiration time (e.g., 1 hour) or may be set to expire when the workload has completed communicating with the service or a short time period thereafter (e.g., 2 minutes). In some embodiments, the credentials may be cached at the proxy to reduce latency or increase availability if the proxy lost a connection to the IAM server and needs to re-establish the connection or if the service requires re-authentication on some periodic or irregular basis.

In some embodiments, the proxy and the IAM server are both present within the workflow and environment. In some embodiments, the proxy can communicate and intercept the communication from the workload that is intended for the service in a no-code authentication mode, and the workload or the application that is using the workload can operate without being modified.

In some embodiments, the client environment may include code and applications that the organization did not develop internally and instead was either bought or licensed by a third party. In some embodiments, the bought or licensed application within the client environment may try to access a service, and in a no-code authentication mode, the proxy can perform the communications for the workload from the bought or licensed application without any modification to the application itself.

In some embodiments, the organization may have developed an application that functions sufficiently except that the code for generating, retrieving, and/or sending the credentials to the service may be absent or buggy and/or malfunctioning. In this situation, the organization may deploy a proxy that can inject the correct credentials so that the workload may access the service and there is no disruption in the workload (e.g., the developer does not have to spend time and resources trying to determine how to fix the secure access within the application).

In some embodiments, a long-lived secret may be replaced by a short-lived secret using the proxy. In some embodiments, the application may use a username and password or application programming interface key which can include the long-lived secret. In some embodiments, the long-lived credential can be replaced by a short-lived token that is injected by the proxy, if for example the service can also accept short-lived tokens. In this situation, since the proxy would receive from the credential provider and send the short-lived token to the service on behalf of the workload, the application would not need to be modified to use short-lived tokens in order to access the service.

In some embodiments, the proxy may not be present in the client environment and instead, the IAM server may communicate directly with the workload in the client environment. In some embodiments, the applications that run the workload in the client's environment may be modified to communicate with the IAM server. In some embodiments, if no proxy is used, a software development kit (SDK) may be provided to a user or developer for the client. In some embodiments, the SDK may be used to integrate the workload or the application executing the workload to communicate with the IAM server.

In some embodiments, the proxy may include an agent controller. In some embodiments, the agent controller may create a trust relationship with the IAM server and manage the communication with the IAM server to retrieve policy directives and access credentials.

### Managing Access Policies

In some embodiments, the IAM system may be used to manage access between a workload and a target service. In some embodiments, the IAM system can manage access without managing secrets for accessing workloads. Typically, secrets (e.g., passwords, private keys, application programming interface keys, etc.) are stored in a vault and accessed when a service needs to verify the client's access credentials using the secret. For example, when one workload in a client environment needs to access a service in a different environment, the workload and service may want to access each other's systems and data for validation and/or data processing. In the process, the secrets that allow the workload and service to access each other may be stored in the vault and used for access. To configure this, administrators on each side may authorize access by generating and using the secrets relating them to a service account. The workload may be given a username and a password for that service account. Creating the username and password for the workload may be performed manually and then sent to the client workload to enter so it can access the target service in the other environment. Some may store the username/password and/or application programming interface key in a vault, and the workload would get the credential from the vault. However, this can lead to a secret zero problem which refers to the problem of needing some initial secret to access any other secret.

Accordingly, disclosed herein are systems and methods of providing access and access management without using secrets. In some embodiments, workload A can access service B and service C based on access policies without using secrets for authentication of Workload A. In some embodiments, when workload A tries to access service B, the IAM system may perform steps to provide access to service B first by authenticating workload A, check the access policy, and deliver the credentials needed to access service B in real time or near real-time. In some embodiments, after the workload A has completed its task, the IAM system may cut-off access to service B, since workload A does not need to maintain access to service B. In some embodiments, the workload A may try to access service B again in the future, and the IAM system can again provide access without using a secret to authenticate workload A.

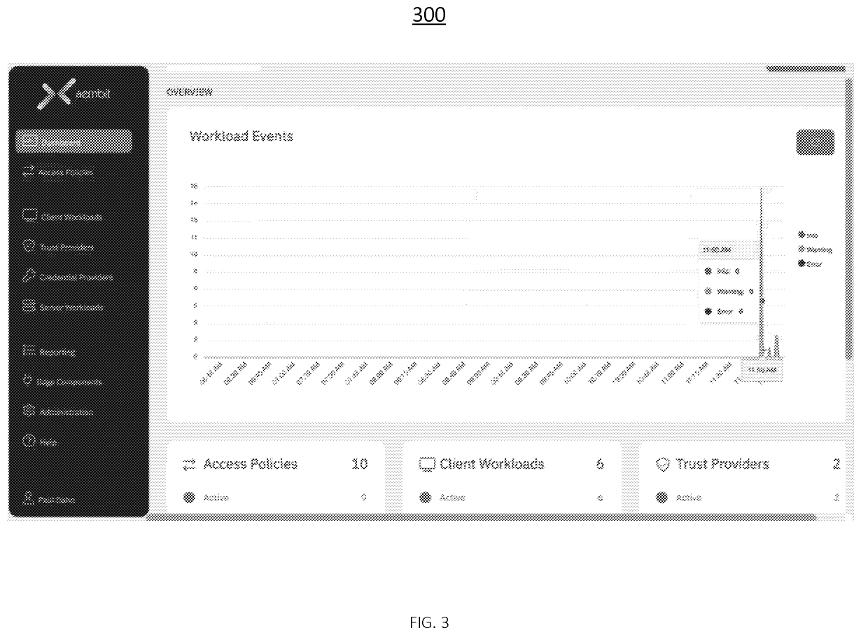

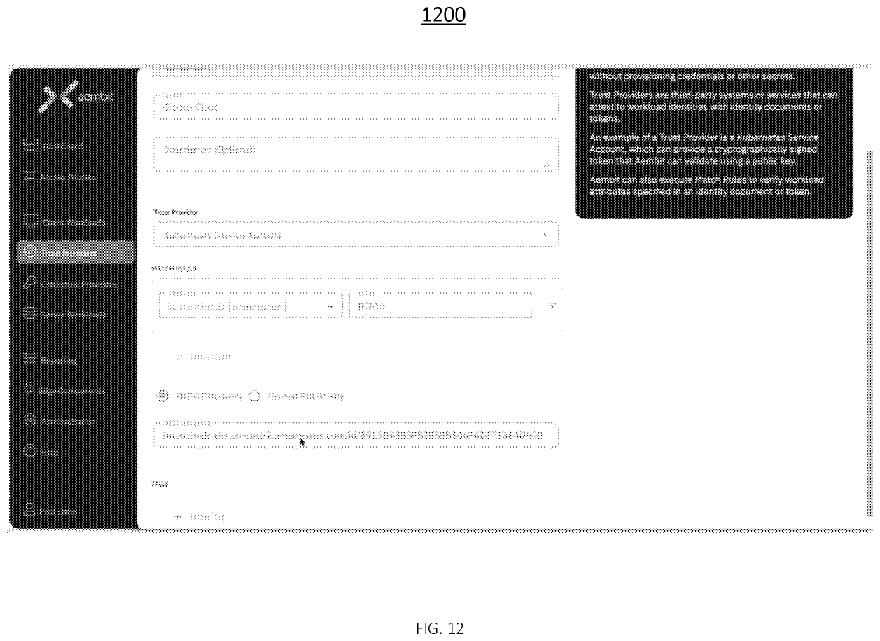

In some embodiments, an administrator or user may create and manage access policies using an IAM console. In some embodiments, the IAM console may include a user interface as described in FIGS. 3-19, but embodiments are not limited thereto. In some embodiments, the IAM console may be connected to the IAM server and/or the proxy and control both.

### Conditional Access

In some embodiments, the system may implement conditional access policies for workloads, similar to conditional access for user access. In some embodiments, access may be granted if additional criteria are also satisfied. In some embodiments, the additional criteria for user access may be called conditional access in this disclosure.

In some embodiments, conditional access may be applied for workloads. For example, an organization might want to verify when Workload A is trying to access Service B, that Workload A is operating in the expected environment (e.g., the appropriate Kubernetes cluster or the appropriate AWS VPC). As further examples, the company may want to verify that Workload A is running on a host that has good posture and has been checked by a cybersecurity software or that the container is managed in an environment that has been verified by a cloud security software. In some embodiments, conditional access may include verifying the results of various software checks and scans. For example, conditional access may include making sure that the container or workload has passed every check in the last 24 hours or that certain optional scans have been completed. Other conditional access examples may include the IP address of the client workload or the time and location of access.

In some embodiments, the admins of the client environment may be given options to select one or more criteria to check for the conditional access. In some embodiments, the admins may select not to use conditional access. In some embodiments, the effect of a conditional access failure may not be to deny access but may be to alert on a failure and to investigate and remediate the failure later.

### End-to-End Logging

In some embodiments, a logging module within the IAM server or IAM system may log each access event and associated details. In some embodiments, the logging module may reside in a database that is connected to the IAM server and/or part of the IAM system. In some embodiments, an access event may include whenever a workload tries to access different services using the IAM system. In some embodiments, access events may also include any step performed by the IAM system to generate and provide credentials to the services to provide the access. In some embodiments, the access event may include any attempt by the workload, any successes to access the service, and any failed attempts to access the service. In some embodiments, access events may include access that is not governed by the IAM system, allowing discovery of access patterns.

In some embodiments, data associated with access event may also be logged. In some embodiments, the data may include the function within the organization who had initiated or started the workload that requested the credentials, the location of where the compute resource is, an IP address, the service that was trying to be accessed, reasons for denial and/or failure of the access request, protocol used by the workload and/or data transfer/communication, event type (e.g., request/response, open/close), protocol specific header information, connection result or connection error information, and others. In some embodiments, the data may include the time of the access request, the time of the success event, the time of the failure event, the time of the end of the service access.

In some embodiments, the logged information including the access events and associated data may be collected and used for further processing and analysis by the organization. For example, the logged information may provide data on which services are most accessed, the most common reasons for failure events, how long resources are utilized, etc. In some embodiments, one or more patterns that are obtained from the logged information may be used to improve utilization of resources, such as reducing the number of compute resources when less than a threshold percentage is ever used, increasing the number of compute resources when more than a threshold percentage is used, etc.

### Discovery

In some embodiments, the proxy may monitor the traffic coming out of the workload and derive insights from the traffic. In some embodiments, the insights may be provided to the IAM server and provided to the user via a user interface. In some embodiments, the traffic data may be similar to or the same as the logs generated with the end-to-end logging. In some embodiments, the user may be able to use the insights and make improved decisions. In some embodiments, the discovery may be performed using a machine learning model. For example, the machine learning model may be used to identify patterns in the insights and/or logs.

In some embodiments, a discovery service or module may reside in the IAM server and present the logged information in a readable format and assist in the process of creating an access policy around the derived insights. For example, if it is discovered that when Service A is accessed that 4 other services are always accessed at around the same time by the same workload. Then, the IAM server may create an access policy that states whenever access to Service A is requested, requests for the 4 other services are also submitted back-to-back or in parallel. This can help reduce the time it takes for the workload to access multiple services. In some embodiments, the discovery service may analyze the access and authentication activity that has been logged and provide administrators with information regarding any anomalous activity, which may indicate a security breach and/or compromised workload.

### Example Workflow

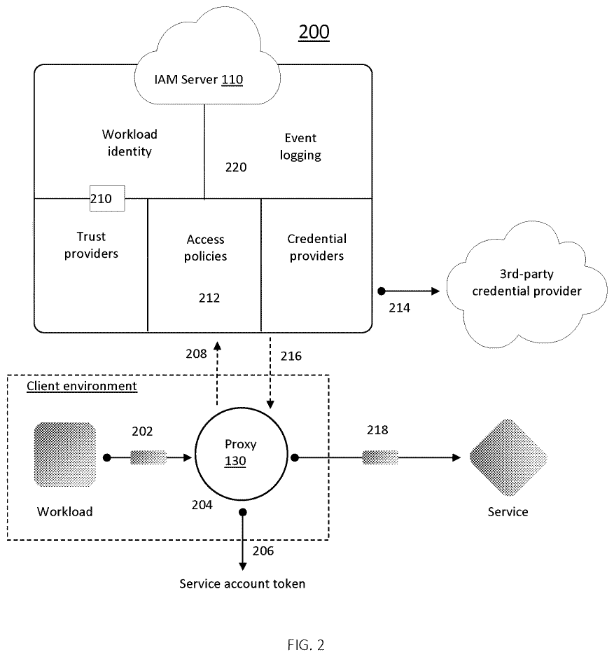

FIG. 2 shows an example of a workflow of implementing the workflow identity and access management, in accordance with some embodiments. In some embodiments, one or more steps may be omitted or additional steps may be added without departing from the spirit of this disclosure. In some embodiments, some of the described steps may be performed in a different order, combined into one step, or broken into additional sub-steps.

In some embodiments, a client workload (e.g., workload 120) may make a request to a service (e.g., service 140) (202). In some embodiments, a custom or packaged software or application that the organization developed may make a request to a SaaS service, application programming interface, database, or a service.

In some embodiments, the client workload may be trying to access a service on another cloud environment. In some embodiments, the IAM system may be used to federate access between different services in different environments. For example, a client application of one company may be trying to access a database being hosted by a service application of another company, and the IAM system described herein can federate the access policies and management between the workload/client organization and the service/target organization. In another example, a client application may be an e-commerce website that uses a payment processor, and the IAM system can federate the communication and access between the two services. In some embodiments, one organization's application may use multiple services, and the system may federate with all of the workloads and services.

In some embodiments, the proxy may intercept the client request for access to a workload (204). In some embodiments, the proxy includes a transparent forward proxy, deployed as a sidecar or agent, which injects service credentials without workload code changes. In some embodiments, the proxy may perform transport layer security (TLS) decryption for data communication via HTTPS and TLS.

In some embodiments, after the request is received by the proxy, the proxy may try to determine or verify that the request indeed came from the client workload via attestation (206). This is done by configuring a trust provider at the IAM Server to trust attestation documents or authentication tokens from the client environment. In some embodiments, an authentication token may include a service account token, a metadata service, and other authentication methods in any virtual or cloud environment. The term “authentication token” may also be referred to as attestation token which are utilized interchangeably throughout the specification. In some embodiments, attestation may include the proxy requesting a service account token from Kubernetes or a metadata service of the client environment that can attest or assert to the identity of the workload. In some embodiments, the authentication token may be associated with a container of a virtual compute environment (e.g., Kubernetes, Amazon EC2, Microsoft Azure, Google Cloud Platform, etc.). In some embodiments, the authentication token may include identifying information, of the container or cluster to which the container belongs, that is digitally signed by a private key that is only known to the cluster or compute environment of the client, and a trust provider at the IAM server may have the public key that is associated with the private key. In some embodiments, the workload may not know the authentication token. In some embodiments, the proxy can transmit the authentication token signed by the private key to the trust provider (208). In some embodiments, using a trust provider that was configured to trust the workload's environment, the IAM server may cryptographically validate the workload's identity. In some embodiments, the trust provider can verify the authentication token using the public key (210). Once the verification is complete, the proxy can verify or authenticate the identity of the workload, without the workload having to provide a username/password or application programming interface key or other identity secret. In some embodiments, third-party trust providers may be used. In addition to verifying the authentication token using the public key, the trust provider may validate matches with other fields of the authentication token.

In some embodiments, attestation may be performed every time a workload tries to access a service, even if it is a service that the workload has accessed before. In some embodiments, the attestation may be performed dynamically when after the workload requests access to the service. In some embodiments, the proxy may temporarily cache the credentials for the service as described elsewhere herein.

In some embodiments, the workload does not know the authentication token or any identity secret to access the service. Typically a workload that accesses using a username/password or an application programming interface key may save the secret which can be compromised by weaknesses in the code of the workload or by a nefarious actor. However, in some embodiments, the workload is not exposed to any secret, such that no secret can be compromised.

In some embodiments, the IAM server may check the access policy for the workload (212). In some embodiments, the access policies may be defined in the IAM server (or a database connected thereto) by the client to manage access between the client workloads and the services. In some embodiments, the access policy may define whether the client workload is allowed to access the service.

In some embodiments, the IAM server may request an access credential from a credential provider (214). In some embodiments, the credential provider may generate credentials that are short or long lived for different services that the client workloads are trying to access. In some embodiments, the credential provider may generate credentials that the service is expecting for the workload that is requesting access to the service.

In some embodiments, the service may be configured to accept credentials that are generated by the credential provider of the IAM server. This configuration creates a trust relationship between the service and the credential provider of the IAM server. This trust relationship either allows the credential provider to request credentials from the service, or for the credential provider to create credentials that are trusted by the service.

In some embodiments, the credential servers in the IAM server can mint credentials that are accepted by the service. In some embodiments, the authentication is performed based on public/private key cryptography. In some embodiments, the administrator can configure the target service to accept tokens signed by the credential provider by providing the service with the credential provider's public key. Then, when the proxy attempts to log-in, the credential provider creates a token and signs it using its private key. The token is provided to the service and the service uses the public key to validate the token is signed by the correct private key. In some embodiments, certain metadata identifying the client may be part of the token. In some embodiments, certain metadata defining access rights may be part of the token.

In some embodiments, the IAM server may respond to the proxy with the access policy and access credential (the token) (216). In some embodiments, the access credentials may be used to log into the service that is being requested by the workload.

In some embodiments, the proxy may inject a credential into the client request and forward it to the service (218). In some embodiments, workload itself never sees or stores the credentials. In some embodiments, the standard communication may continue between workload and service via the proxy or without the proxy. In some embodiments, the service or any application thereof is not modified in order to work with the proxy and the IAM server.

In some embodiments, the proxy may send an access event log to the IAM server (220). In some embodiments, the access request and access metadata can be logged for analytics, auditing, and compliance.

### User Interfaces

FIGS. 3-19 show example screenshots of a user interface of the IAM console, in accordance with some embodiments. In some embodiments, the IAM console may be used by users of the organization (e.g., DevOps and/or security teams) to manage the workload access policies and other aspects described in this disclosure. Although various example screenshots have been shown, embodiments are not limited to the example screenshots shown, and the user interface may vary depending on embodiments.

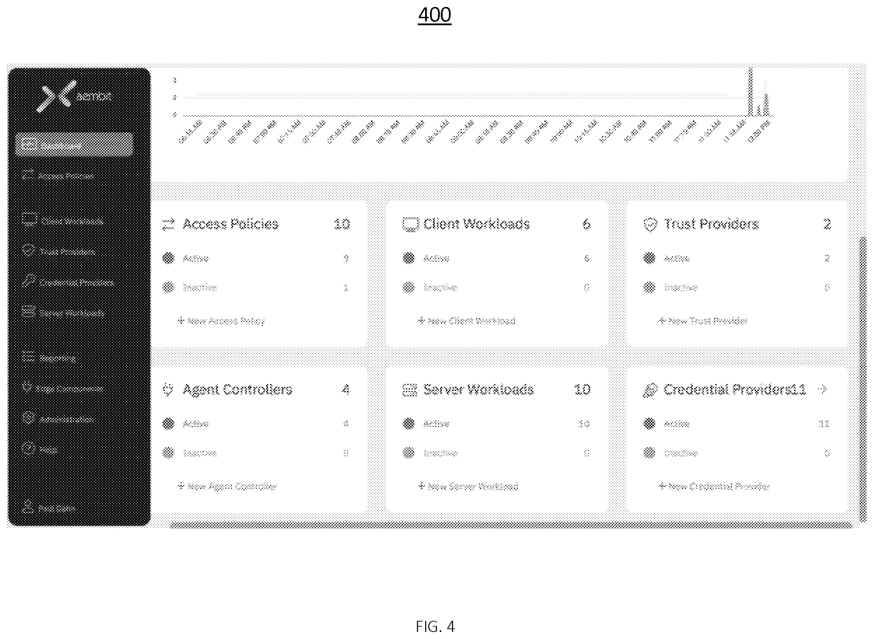

FIGS. 3 and 4 show example screenshots 300, 400 of a dashboard page of the IAM console, in accordance with some embodiments. In some embodiments, the dashboard shows any workload access activity (e.g., access events) that have been logged. In some embodiments, each event may be categorized into “info” to indicate that the workload access for that event is behaving normally, a “warning” to indicate that there may be an issue with the workload event, and “error” to indicate that there was a workload event that did failed. In some embodiments, the dashboard may also include statistics on various metrics such as the active and inactive numbers of access policies, client workloads, trust providers, agent controllers, target services, and credential providers.

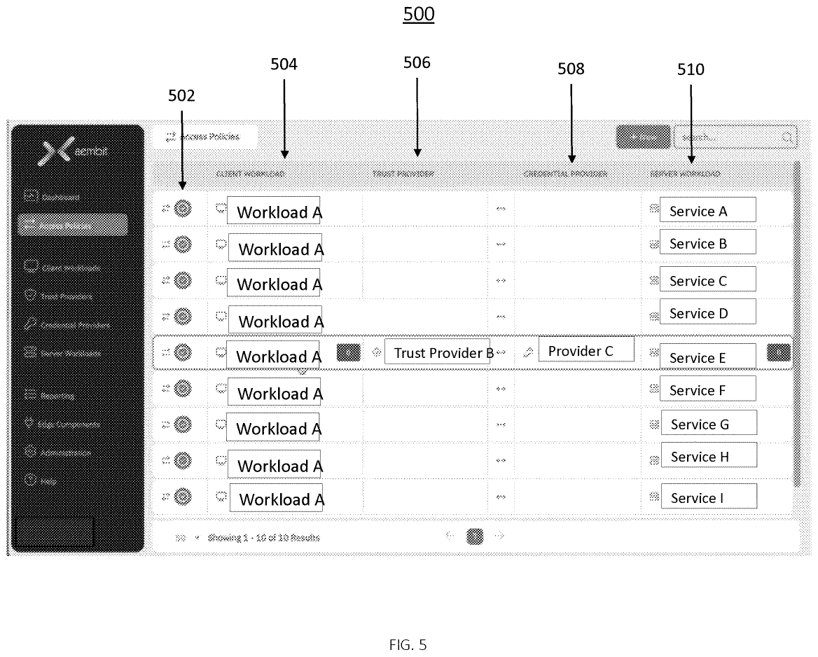

FIG. 5 shows an example screenshot of an access policies page of the IAM console, in accordance with some embodiments. In some embodiments, the access policies page includes a list of access policies that are currently set or can be set by the administrative user. A first column 502 may indicate based on a color-coding, for example, whether the access policy is active or inactive. A second column 504 may include a list of client workloads for which the access policy is set. A third column 506 may include a list of trust providers that the IAM server may use to verify identity of the client workload in the second column 504. A fourth column 508 may include a list of credential providers that can be used to generate or retrieve access credentials for the service that is listed under a fifth column 510.

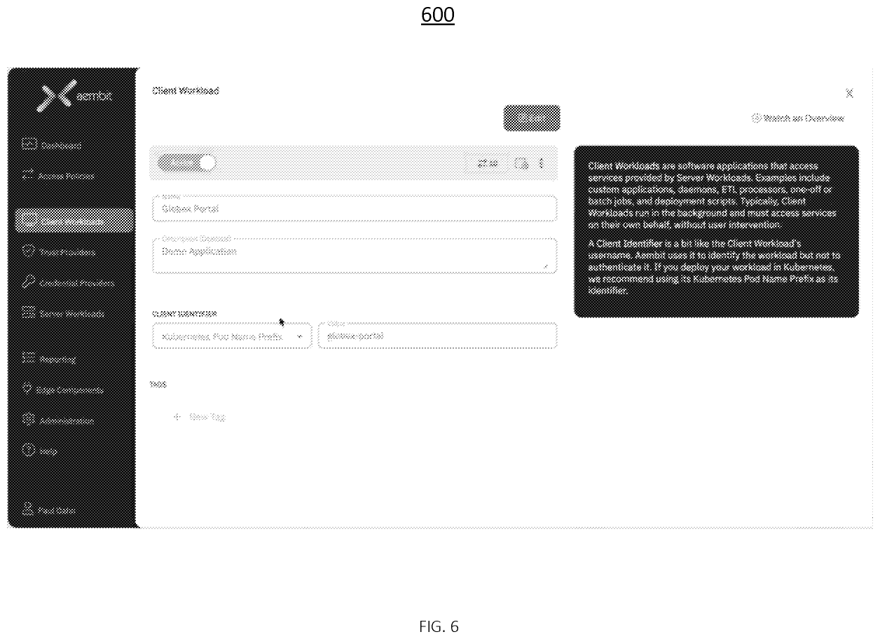

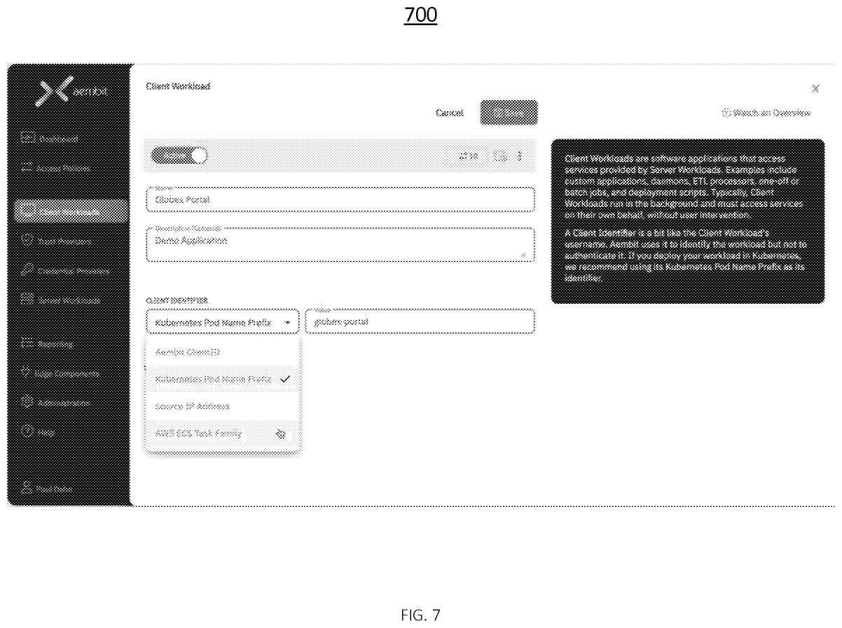

FIGS. 6 and 7 show example screenshots 600, 700 of a client workload's page of the IAM console, in accordance with some embodiments. In the client workloads page, the user may include details about the client workload for which the user wants to create an access policy. The information provided in the client workloads page can include information that identifies the workload. In some embodiments, the user can identify the client identifier by the type of identifier (e.g., a system-generated client ID, Kubernetes pod name prefix, source IP address, or AWS ECS task family) and a value for the identifier. After the appropriate client identifier information is input, the IAM server can use this information to obtain the authentication token for the attestation process.

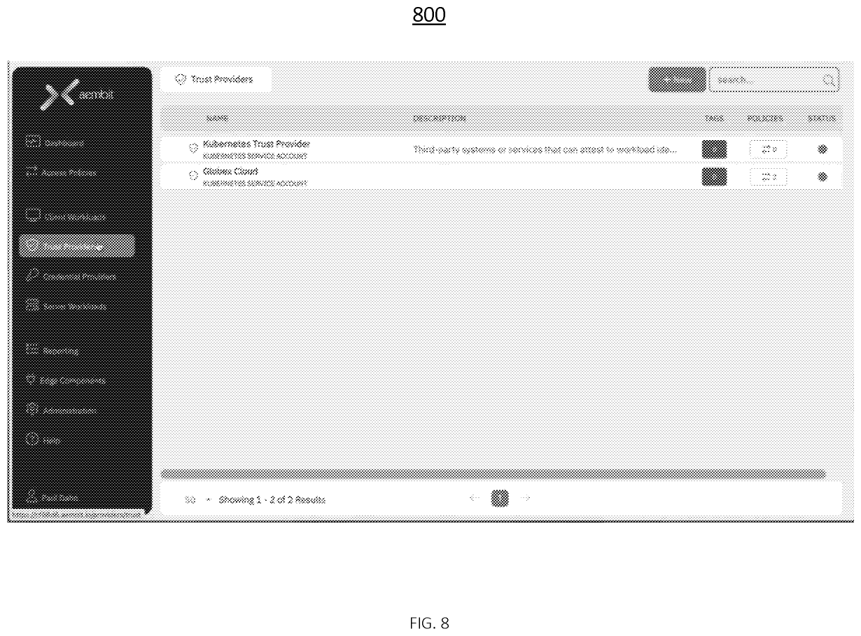

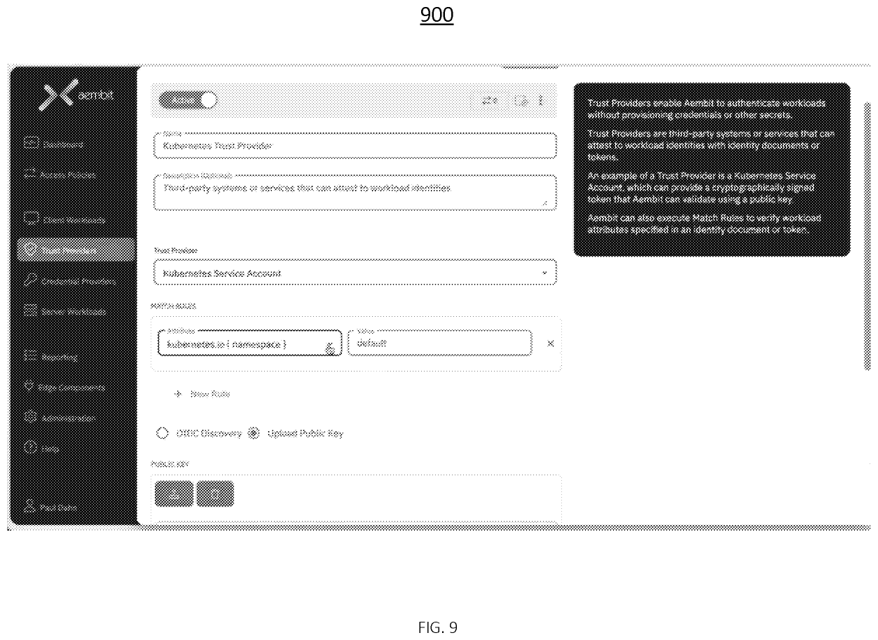

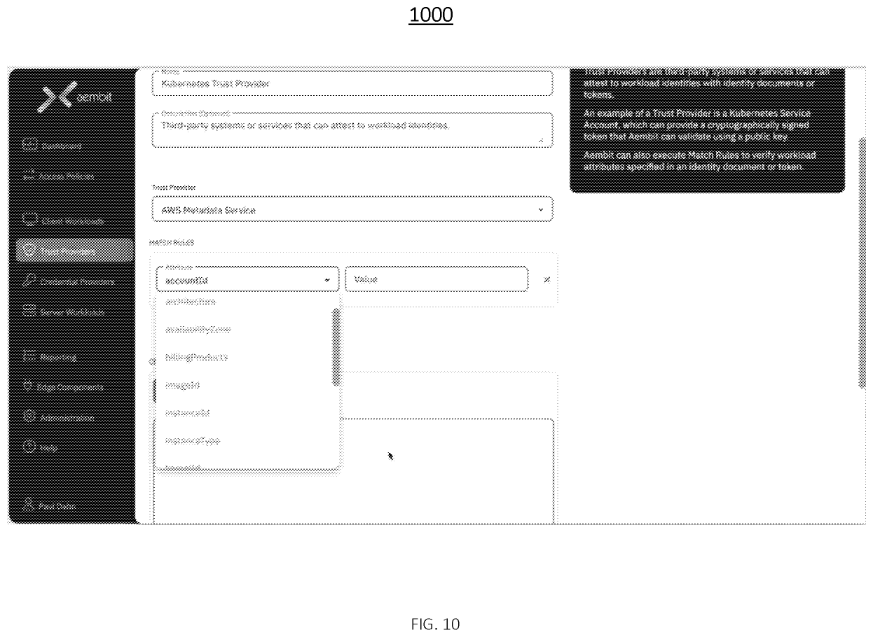

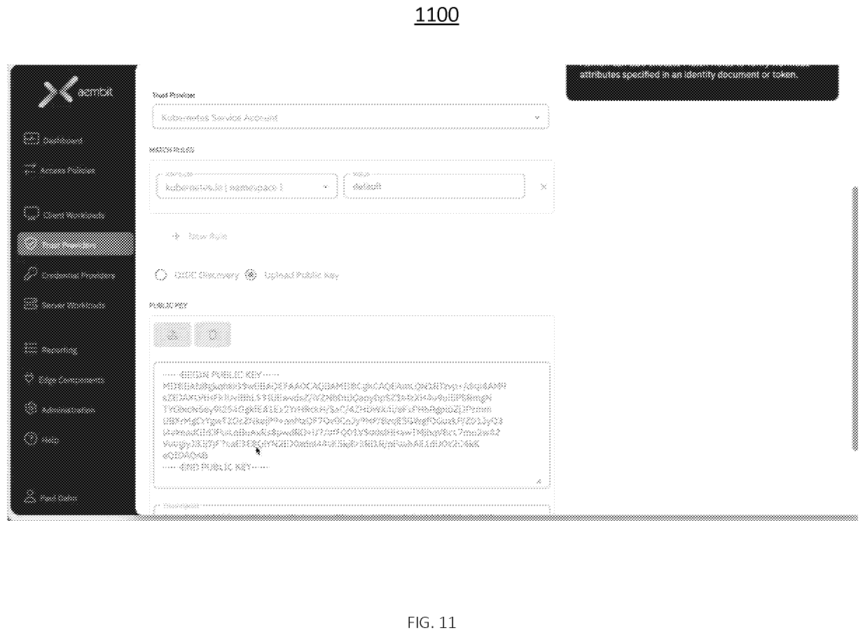

FIGS. 8-12 show example screenshots 800, 900, 1000, 1100, 1200 of a trust providers page of the IAM console, in accordance with some embodiments. As shown in FIG. 8, a list of existing trust providers may be provided. As shown in FIG. 9, information related to the trust provider may be provided including the type of trust provider under “Trust Provider” and match rules that use the type of identifying information and the identifying information's value. In some embodiments, the configuration for the trust provider may include the type of client workload (e.g., Kubernetes Cluster). As shown in FIG. 10, the user may also provide the attribute for the cluster identifying information that will be signed by the metadata service using the private key. The identifying information can include, e.g., architecture, availabilityZone, billingProducts, imageld, instanceld, instanceType, etc. As shown in FIG. 11, the user may also specify the public key (that matches the private key) that will be used to verify the service token account. In some embodiments, if the client is using Amazon AWS, the user may identify the identifying information as the account information or instance ID, etc. Then the proxy may receive a certificate that includes the authentication token that can be transmitted to the IAM server for verification.

In some embodiments, an OpenID Connect (OIDC) may be used by identifying the OIDC endpoint. Then the IAM server may access the endpoint, retrieve the public key, and use the key to verify the identity document. By using the OIDC process, the process of obtaining the public key information can be automated, rather than the user putting in the public key information in the IAM console, and the IAM server may be able to use the latest public key.

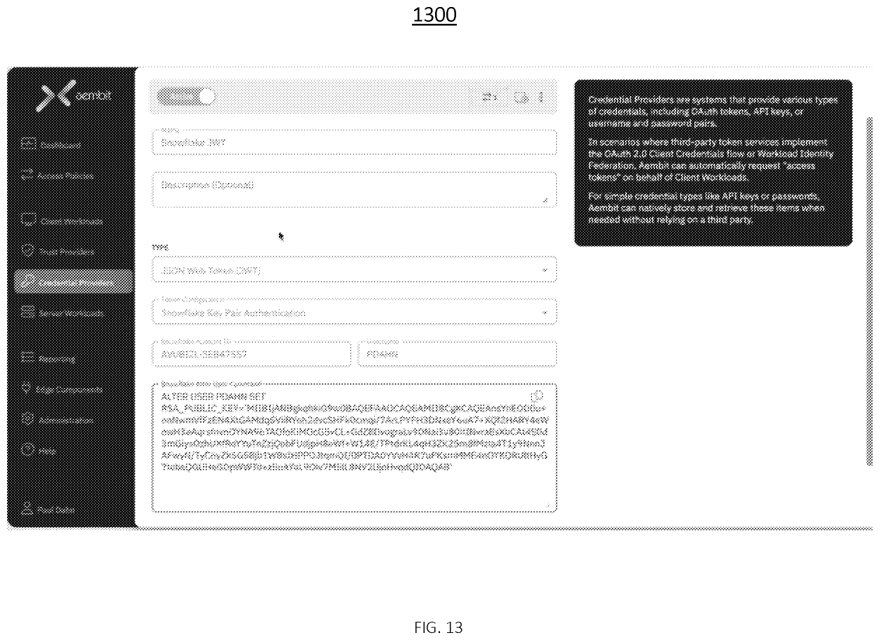

FIG. 13 shows an example screenshot 1300 of a credential providers page of the IAM console, in accordance with some embodiments. The credentials can include long-lived and short-lived credentials. The long-lived credentials can include usernames/passwords or application programming interface keys, and short-lived credentials can include OAuth or a JSON web token (JWT). For JWT and OAuth, the system may use a third party credential provider to retrieve that OAuth token. In some embodiments, the system may generate the JWT. The system may manage the JWT for the client.

In some embodiments, the IAM system may generate the key pair and give the public key to the client user while the private key remains within the IAM server. Then the workload identity may be authenticated as discussed elsewhere herein.

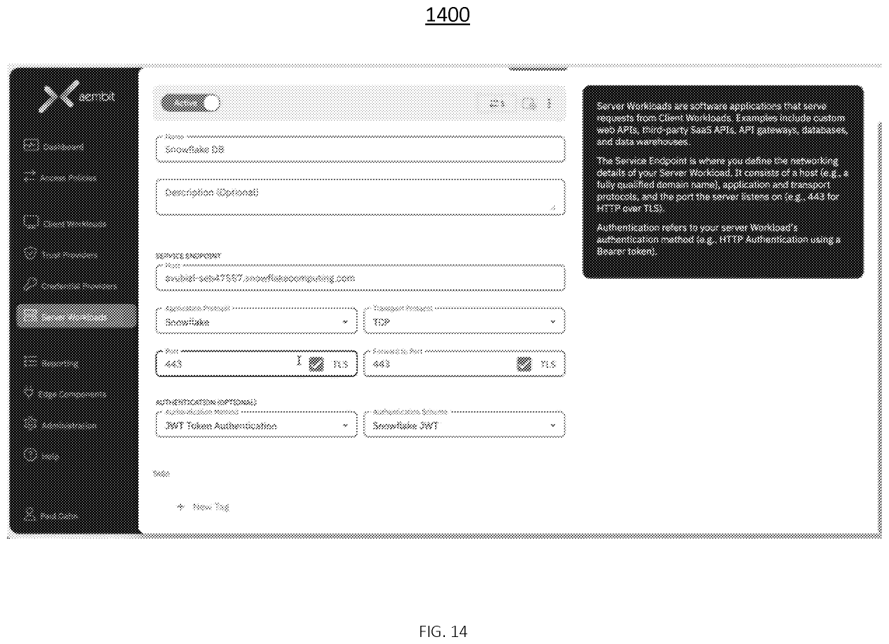

FIG. 14 shows example screenshots 1400 of a server workloads page of the IAM console, in accordance with some embodiments. The server workloads or target services may be defined using the server workloads page. For example, the user may define the host that it is connecting to along with what port of that the service that the proxy will be connecting to. In some embodiments, the “Port” includes the port that the client workload connects to which is intercepted by the proxy. In some embodiments, the “Forward to Port” includes the port the proxy then sends the traffic to on the target service. This allows the proxy to forward the traffic to a different port than it received the traffic on. This could be useful, for example, if the client workload made an unencrypted HTTP connection on port A and after intercepting the connection the proxy forwarded the connection to the target service as an encrypted connection on port B.

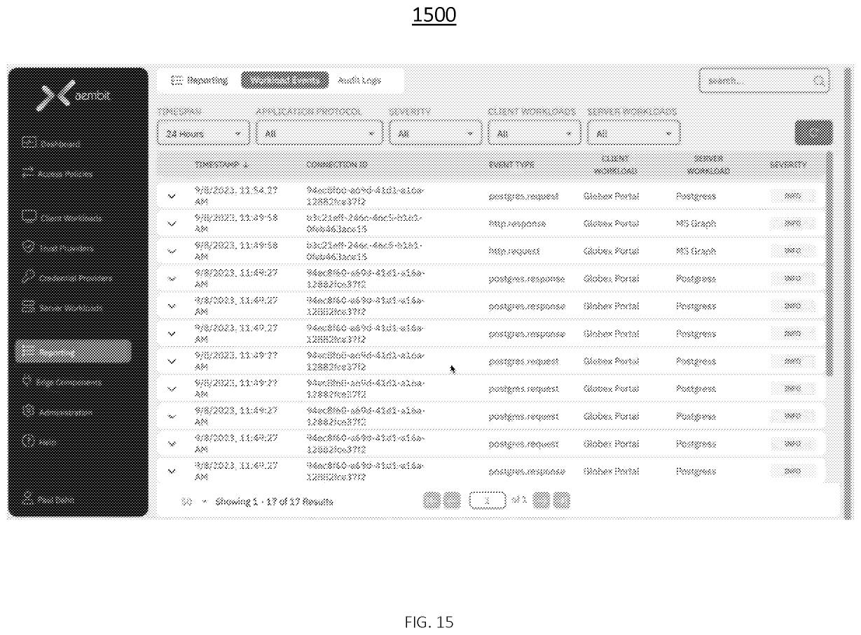

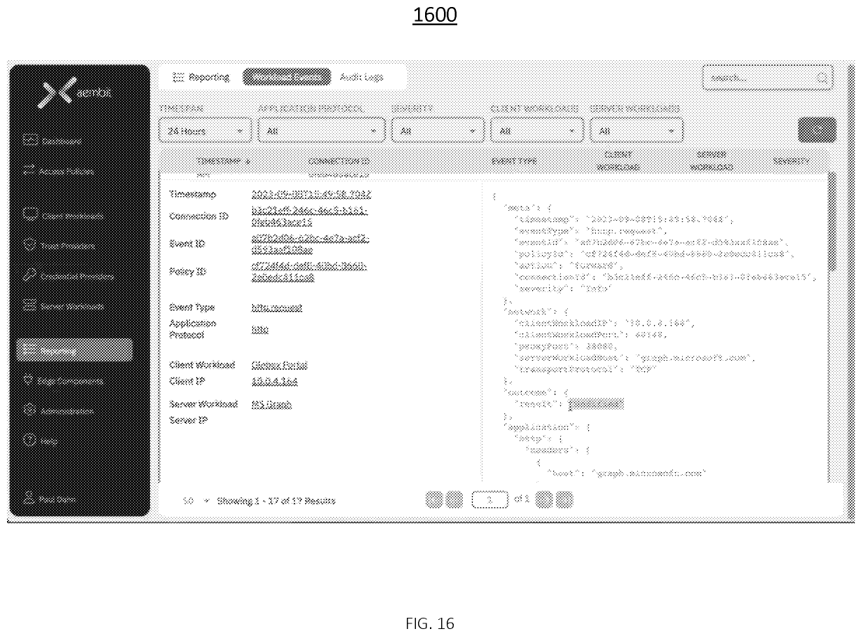

FIGS. 15 and 16 show example screenshots 1500, 1600 of a reporting page of the IAM console, in accordance with some embodiments. In some embodiments, the IAM server may log all access attempts, both successful and unsuccessful attempts. The logging info may include every time a public key was used to access the service and what client used it to access that service. In some embodiments, the IAM server logs metadata about the connection including where the metadata is coming from, what IP address, client workload information, where the metadata and/or client workload request is going, whether to modify the metadata, whether to just pass the metadata through, etc.

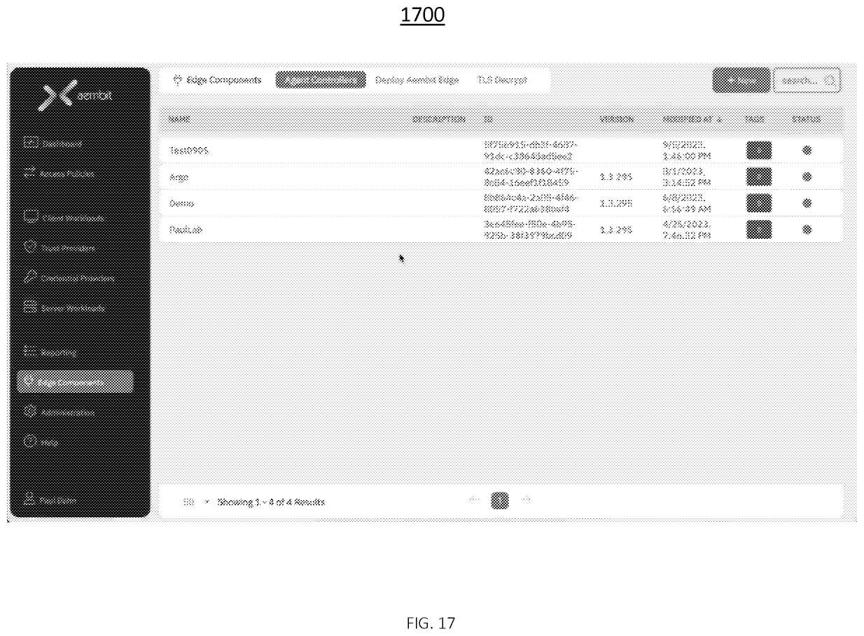

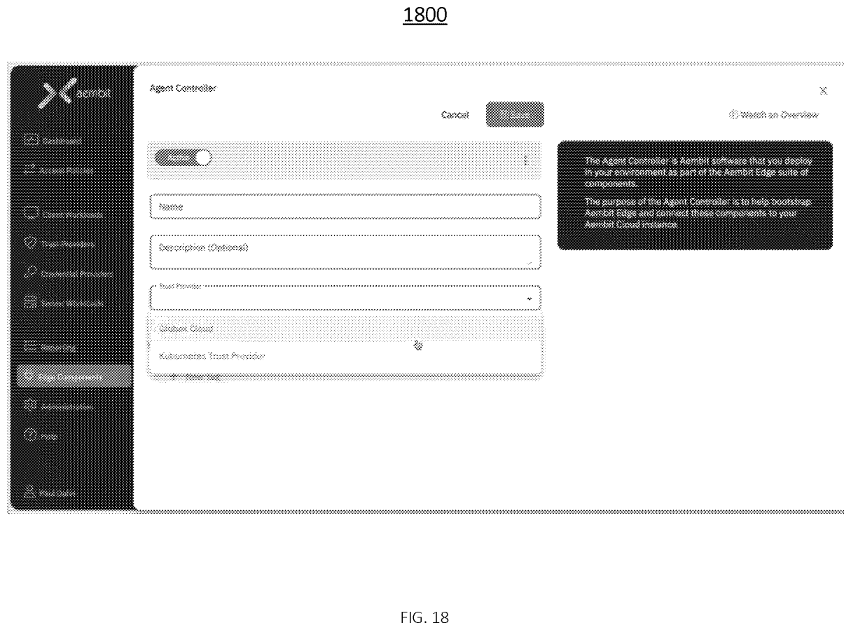

FIGS. 17 and 18 show example screenshots 1700, 1800 of a cloud components page of the IAM console, in accordance with some embodiments. The cloud components page may be used to configure the cloud components include, e.g., the agent controller.

### Control Plane as Identity Broker for Workloads

The present disclosure provides systems and methods for managing identities and access of non-human (NH) entities such as software workloads or applications, featuring a centralized policy database, robust workload authentication, conditional access mechanism, and comprehensive end-to-end logging. The management for NH access or access between software workloads (i.e., between client workload and service workload) may be provided as a control plane for generating access decision and issuance of the access credential, while the access to the service may not traverse the cloud service of the access management.

In some embodiments, the system comprises at least one Automated Workload Identity and Access Management Controller. In some cases, the controller comprises at least one token service that implements protocols like the OAuth 2.0 Client Credentials flow, or Workload Identity Federation. In some instances, this controller is configured to automatically request and provide access tokens on behalf of Client Workloads. For example, the controller may natively store and retrieves simple credential types such as API keys or passwords without relying on a third party. The controller may integrate a conditional access management module, which grants access based on satisfaction of certain pre-defined conditions, enhancing the security and efficiency of workload access management within various computing environments.

In some embodiments, the system comprises at least one non-human identity and access management (NH-IAM) controller. In some cases, the at least one NH-IAM controller comprises at least one policy management module. In some instances, the at least one policy management module comprises a centralized policy database for managing access between workloads and services. In some cases, the at least one NH-IAM controller comprises at least one authentication module. In some instances, the at least one authentication module comprises a strong workload authentication mechanism and a conditional access mechanism. For example, the at least one NH-IAM controller may be configured to issue short-lived access credentials based on the policies in the centralized policy database and the authentication results from the authentication module. In further examples, the system comprises at least one logging module for end-to-end logging, providing comprehensive visibility and control over non-human access within the enterprise's IT ecosystems. As an example, the at least one logging module may comprises specific functionalities for end-to-end logging to provide comprehensive visibility and control over user access. The logging module may be configured to log all access attempts, both successful and unsuccessful, and associated data. In some instances, the non-human identity and access management system enhances security and operational efficiency by automating the access control process and reducing the risk of security breaches.

The access management system may improve the access between non-human entities, also referred to as workloads or software workloads. As described above, a client workload may access a service workload. In some instances, the system may comprise workloads in various environments like a cloud or a datacenter. Additionally, the system may comprise different types of workloads, including custom software, pre-packaged software, Virtual Machines (VMs), Kubernetes containers, or Serverless functions. In further instances, the system may comprise workloads such as Software as a Service (Saas) services, Cloud application programming interfaces, or robotic functions. For example, the system may comprise managing these diverse workloads to improve the overall efficiency and security of the system. In further examples, the system may streamline the access process between client workloads and service workloads, reducing complexities and improving operational efficiency.

Unlike existing methods that often manage non-human access in an ad-hoc manner, the systems and methods provided herein offer a systematic approach to managing non-human access, providing a marked shift from the traditional practice of managing user access through IAM in enterprises.

In some embodiments, the method may comprise multi-factor authentication (MFA) for user IAM. In some cases, the method may comprise IAM verifying the identity of the user and checking an access policy and conditional access. In some instances, the method may comprise IAM returning a short-lived access credential, such as a SAML token, to the user. Additionally, the method may comprise the user's use of the SAML token to log into the service. In further instances, the method may comprise ensuring that access to the service is authenticated and authorized to enhance security. For example, the method may comprise repeating the process for each access request to ensure up-to-date authentication and authorization.

In some embodiments, the method may comprise implementing an Identity and Access Management (IAM) approach specifically for non-human access. In some cases, the method may comprise improving security and managing access between various workloads. In some instances, the method may comprise centrally controlling access by implementing policies instead of directly managing secrets. Additionally, the method may comprise formulating policies based on the identity of the workload rather than possession of an access credential. In further instances, the method may comprise assisting enterprises in their transition from using long-lived secrets to employing short-lived access credentials. For example, the method may comprise leveraging these strategies to enhance security and operational efficiency across the enterprise.

In some embodiments, the method may comprise cryptographically authenticating client workloads without requiring an identity credential. In some cases, the method may provide a level of security similar to Multi-Factor Authentication (MFA). In some instances, the method may comprise the use of conditional access to assess the health, posture, and context of a client workload before granting access. Additionally, the method may comprise applying enhanced security measures before granting access to sensitive data or functions. In further instances, the method may comprise the implementation of rigorous and multi-layered access controls to reduce the risk of unauthorized access. For example, the method may comprise additional safeguards to prevent unauthorized access even if one security layer is compromised. In further examples, the method may contribute to the enhancement of the overall security of the IT ecosystem in which the client and server workloads operate.

In some embodiments, the method may comprise a feature that provides end-to-end logging, which may be utilized in audit trails. In some cases, the method may comprise the enhancement of security and improved operational processes. In some instances, the method may comprise the creation of a policy wall between administrators and credentials. Additionally, the method may comprise managing access through the implementation of policies, rather than through the direct control of credentials. In further instances, the method may comprise the reduction of the potential for unauthorized access due to policy-based control. For example, the method may comprise reducing the risk of unauthorized access and enhancing the overall security by handling access through policies instead of directly through credentials. In further examples, the method may comprise the addition of an extra layer of security by not allowing administrators direct access to the credentials, thereby simplifying the process for administrators while maintaining high-level security.

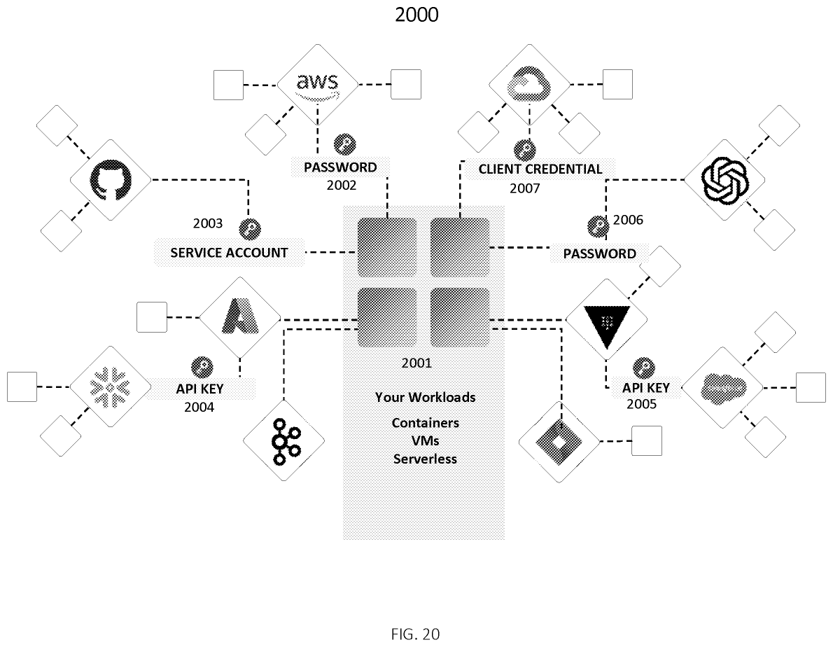

FIG. 20 shows an example of a system (2000) that handles the identity and access of various workloads (2001) in a distributed application environment. The system may comprise a variety of connection points, each with different types of credentials, such as a password (2002), a service account (2003), and two kinds of application programming interface keys (2004 and 2005). Additionally, the system may comprise the use of a password (2006) and a client credential (2007) for access to services resembling a chat service and a cloud storage service, respectively. The key purpose of this figure is to illustrate an existing system that does not include the advanced identity and access management mechanisms, showcasing the challenges and complexities that can arise when managing access in distributed environments without an efficient IAM system.

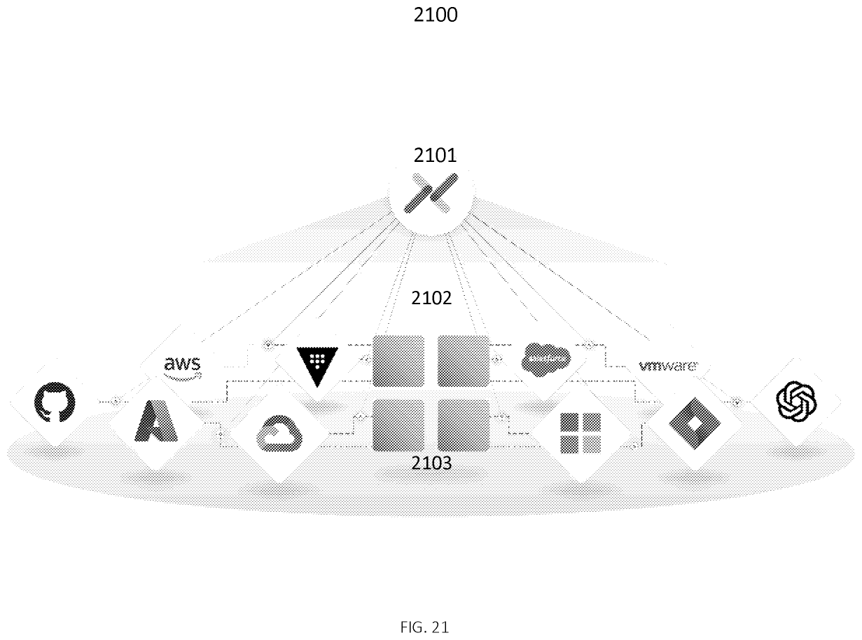

FIG. 21 shows an example of a system (2101) configured to manage the identity and access of encapsulated software units, or ‘containers’ (2103), within a distributed application context. The system may comprise superior flexibility that manages any-to-any access across an array of environments, including Hyperscalers, Data Centers, and Cloud application programming interfaces (2105), demonstrating its broad adaptability. In some instances, the system (2101) may be largely automated and can manage machine credentials autonomously (2107), reducing the need for human intervention. Additionally, the system may comprise a no-code authentication solution (2109) provided by the system, simplifying the process of securing access. The system may embody a secretless, identity-driven, and policy-based approach to access management, enhancing the overall security of the authentication process. This system contrasts with those depicted in FIG. 20, showcasing significant enhancements in managing complex interactions within a distributed application environment.

In some embodiments, the system operates in the control plane while access between the client workload and services occurs directly. In some cases, this control plane comprises at least one module that takes an identity credential and returns an access credential, providing secure and simplified access management for software units or containers within a distributed application context. In certain scenarios, the single control plane is largely automated and manages machine credentials autonomously, reducing the need for human intervention. The control plane is also configured to support transitions towards secretless access and zero trust, accelerating these critical shifts in access management. This not only enhances security but also simplifies governance and compliance practices, making the system an effective solution for managing complex interactions within a distributed application environment.

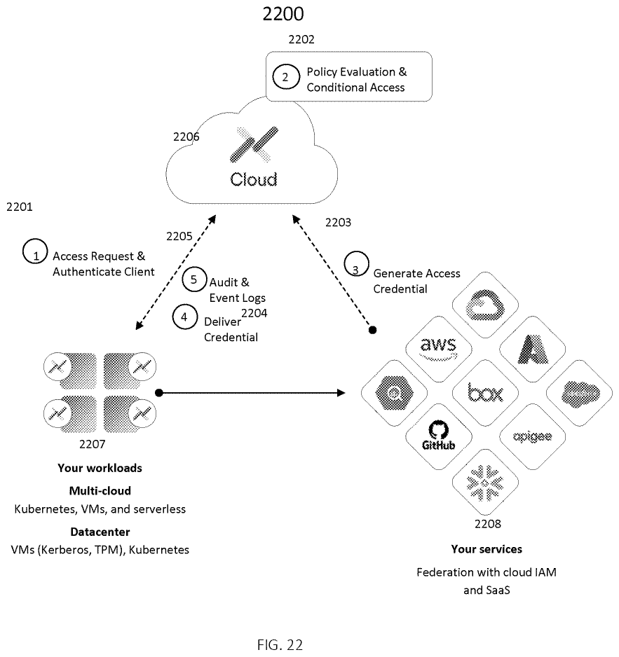

FIG. 22 shows an example of a system architecture (2200) for a Workload Identity Broker. The system architecture may comprise an Access Request & Authenticate Client component (2201), where the access request from a workload is received and authenticated. In some instances, the system may comprise a policy evaluation & conditional access component (2206) for evaluating the access request against predefined policies and conditional access rules. Additionally, the system may comprise a generate access credential component (2203) for generating or retrieving the appropriate access credentials, a deliver credential component (2204) for delivering the generated credentials to the client workload, and an audit & event logs component (2205) configured to log some or all access events and related metadata. In some embodiments, workloads may comprise computational entities. In some cases, the computational entities may comprise multi-cloud Kubernetes, VMs, and serverless functions (2207). In some instances, the computational entities or workloads may access services from any environment. For example, the environment may comprise a cloud IAM and/or SaaS (2208).

In some embodiments, the system comprises at least one control plane operation module. In some cases, the at least one control plane operation module comprises at least one no-code authentication feature. In some instances, the no-code authentication feature may be configured to provide security and management to developers, system administrators, the applications and/or services.

In some cases, the at least one control plane operation module comprises at least one modern software development practice module for deployment and scaling. In some instances, the at least one modern software development practice module comprises specific tools and methodologies that allow for efficient deployment and scaling of the system. For example, the at least one control plane operation module may be configured to facilitate workload migration to using short-lived access credentials. As an example, the control plane operation module may enhance security and ease management by shifting workloads to use short-lived access credentials, thereby limiting vulnerability exposure, and reducing administrative tasks.

The present disclosure may comprise a method for managing and securing access between software workloads in a distributed environment. In some embodiments, the method may comprise workload identity authentication, policy-based access control, conditional access validation, and just-in-time credential provisioning. In some cases, the method may be configured such that only authenticated and approved workloads can access the services they need, thereby strengthening security. Moreover, by automating these processes, the method may reduce the administrative burden in both multi-cloud and on-premises systems. In some instances, the method may provide a robust and streamlined solution for managing access in complex software environments.

In some embodiments, the method may comprise operating the system to authorize access between software workloads. In some cases, the method may comprise authenticating the identity of the client workload. In some instances, the method may comprise confirming that access is permitted based on access policies. Additionally, the method may comprise checking if the client workload fulfills conditional access policies. In further instances, the method may comprise granting access by delivering an access credential just-in-time to the client workload. For example, the method may comprise providing the client workload to directly access the service once it has been granted the appropriate access credential. In this way, the method may enhance the security and efficiency of access management between software workloads.

In some embodiments, the method may comprise operating a system that functions as a control plane solution. In some cases, the system may primarily function as an access decision-maker and credential issuer, without necessitating access to traverse through the system's cloud service. In some instances, the system may record all access attempts, both authorized and unauthorized, as well as track the issuance of credentials without recording the actual credentials. In some instances, the system may generate comprehensive end-to-end logs and provide the capability to utilize these logs internally while also offering the flexibility to export them to a selected Security Information and Event Management (SIEM) system.

In some embodiments, the system comprises at least one identity broker for workload identity and access management. In some cases, this identity broker comprises at least one module that implements identity protocols like SPIFFE. The identity broker is largely automated and manages machine credentials autonomously, reducing the need for human intervention. The broker is also configured to support transitions towards secretless access and zero trust, accelerating these critical shifts in access management. Furthermore, the identity broker enhances security and simplifies governance and compliance practices, effectively managing complex interactions within a distributed application environment. In further examples, the identity broker may interface with various cloud environments and trust providers, demonstrating its broad adaptability.

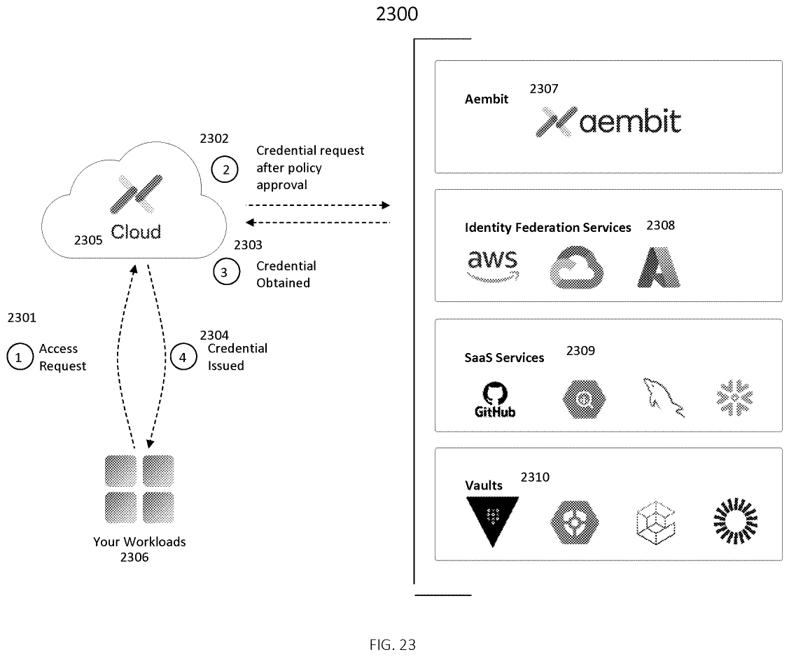

FIG. 23 shows an example of a system architecture (2300), focusing specifically on the functionality of Credential Providers within the system. The system architecture may comprise a ‘Credential Provider’ component (2307) that interacts with different elements to manage access credentials. In some instances, the Credential Provider may mint its own tokens, federate with Software as a Service (Saas) Apps, other Identity Providers (IDPs) (2308), and retrieve credentials from existing Vaults (2310). Additionally, the system may comprise an Access Request (2301) from ‘Workloads’ (2306), and a Credential Request (2302) directed to the Credential Provider after policy approval. Moreover, the Credential Provider may retrieve the requested Credential (2303) and issue the Credential (2304) back to the workload, providing access to the requested service. For example, the credential provider may handle both short and long-lived credentials, implying flexibility in access management. In further examples, the Credential Provider operations such as minting tokens, federating with SaaS Apps and other IDPs, retrieving credentials from existing Vaults, and issuing credentials back to the workload may be operated in a cloud-based environment (2305).

In some embodiments, the method may comprise delivering an access credential to the client workload once an access policy is satisfied. In some cases, the method may comprise delivering the access credential just-in-time for the authenticated workload to access the requested service, ensuring the most up-to-date access credential is used. In some instances, the method may comprise generating a short-lived token as an access credential, such as minting an OpenID Connect (OIDC) token or a signed JSON Web Token (JWT). Additionally, the method may comprise establishing a trust relationship between the service workload and the system.

In some cases, the method may comprise configuring the service workload to trust tokens that are minted by the system. In some instances, the method may comprise enhancing the security and integrity of the system's tokens and the overall trust relationship through the placement of the public key, which corresponds to the system's signing key for that particular service and tenant, into the service. For example, the system may return the minted token to the client workload. As an example, the minted token may map to a service account or a role, or may include claims specifying the rights the client workload has at the service. In some instances, the method may strengthen the security and integrity of the system's tokens by embedding the public key, corresponding to the system's signing key for a particular service and tenant, into the service. The method may enhance the trust in the token's validity by embedding the public key into the service, which authenticates the token's origin and confirms its integrity, ensuring it is free from tampering. Additionally, this setup may establish a robust trust relationship between the workload, system, and service, effectively bolstering the overall security of the system.

In some embodiments, the system may obtain a token from the Software-as-a-Service (SaaS) service that is being accessed. In some cases, the method may comprise configuring the SaaS service (e.g., such as Salesforce) to trust requests from the system and return Open Authorization (OAuth) tokens. In some instances, the system may confirm that there is no pre-existing trust relationship between the client workload and Salesforce. Additionally, the system may be federated with other cloud services to request tokens for access to services in that cloud. In further instances, the system may support long-lived credentials (e.g., such as usernames, passwords, and application programming interface key, which can either be stored within the system or requested from the secrets manager) specified by the enterprise. For example, the method may comprise delivering the credential to the client workload just-in-time, after checking the access policy. In further examples, the method may comprise the system utilizing a two-sided federation architecture through the combination of trust relationships for both trust providers and credential providers.

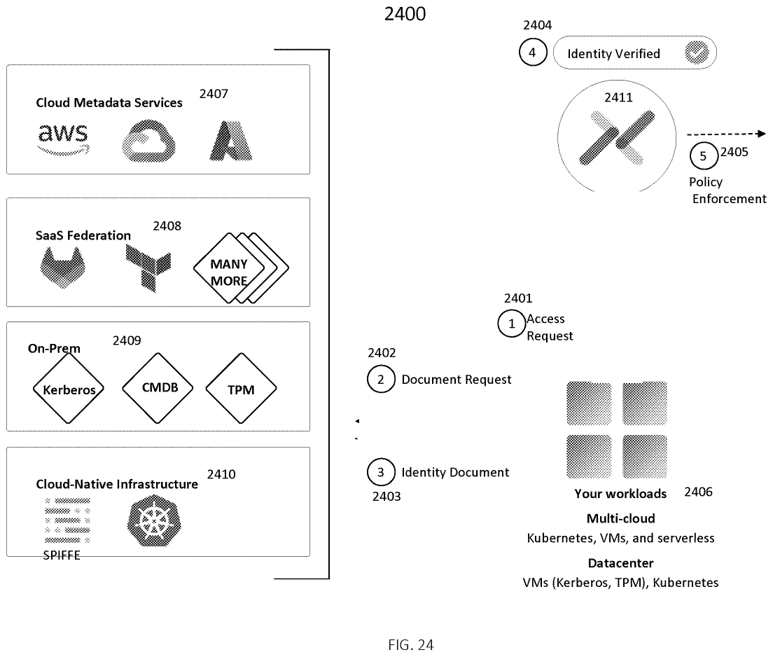

FIG. 24 shows an example of a system architecture (2400) specifically for trust providers. The system architecture may receive an access request (2401) from ‘Managed workloads’ (2406). In some cases, the access request (2401) may be generated by a plurality of computational entities operating in multiple environments. In some instances, a document request (2402) may be sent to various trust providers. For example, the trust provider may comprise cloud metadata services (2407), SaaS federation (2408), on-prem solutions (2409), and cloud-native infrastructure (2410). Additionally, the system may comprise an identity document (2403) being sent back to the managed workloads (2406) from the various trust providers. In further instances, the trust provider (2411) may verify the identity of the workload (e.g., in the identity verified stage) (2404), and carry out policy enforcement (2405). For example, the trust provider may verify identity documents from different environments and operating systems. As an example, the system may be configured to manage trust and verify the identity of workloads across complex distributed environments.

In some embodiments, the system may cryptographically authenticate client workloads. In some cases, the client workload is authenticated through attestation without an identity credential. In some instances, the attestation may utilize the client's compute environment to provide an attestation credential, which testifies to the client's identity. In some instances, the method may comprise a specific client workload, such as a Kubernetes Container, receiving a Service Account Token from the Kubernetes Cluster. For example, the method may generate a short-lived Service Account Token, signed by the Kubernetes Cluster and containing instance and other pertinent information about the container (e.g., adding an extra layer of security). As an example, the method may utilize the client's compute environment and short-lived tokens to secure client authentication in a distributed application environment.

In some embodiments, the method may comprise initiating with integrating standard Kubernetes functionalities, such as Service Account Tokens, into the system. In some cases, the integration may eliminate the need for additional configuration by the enterprise's admin, thereby simplifying the setup process. In some cases, once the setup is simplified, the method may comprise the enterprise admin configuring the system to trust service account tokens from trusted Kubernetes clusters. In some instances, following this trust establishment, the method may progress to merging the enterprise's system tenant with the Kubernetes cluster (e.g., a process known as federation). In some instances, to enhance security during federation, the method may configure the system to trust the public key used by the Kubernetes cluster to sign service account tokens. For example, the method may result in a seamless and secure integration with Kubernetes, enhancing the overall security and operational efficiency of the identity and access management system.

In some embodiments, the method may comprise the client workload delivering the associated service account token to the system to authenticate. In some cases, the method may comprise the system verifying the signature of the submitted token to affirm that it was signed by a trusted environment. In some instances, the method may comprise the system inspecting the token to determine the identity of the container. Additionally, the method may comprise forming the policies based on the identity information in the token and other metadata about the container obtained from the token. In further instances, the method may provide a layered approach for authentication and access control. For example, the method may comprise enhancing robust security by minimizing the risk of unauthorized access.

In some embodiments, the method may comprise authenticating code from other compute environments. In some cases, the method may utilize attestation support from cloud platforms such as AWS, Azure, and GCP for Virtual Machines (VMs). In some instances, the method may utilize metadata documents in the process of attestation in AWS. Additionally, the method may comprise attesting to the identity of Active Directory domain-joined Linux and Windows servers using Kerberos in a datacenter environment. In further instances, the method may comprise employing Trusted Platform Modules (TPMs) or virtual TPMs to authenticate Virtual Machines (VMs). For example, the method may comprise using the attestation mechanism to authenticate client workloads strongly cryptographically without requiring the generation or storage of identity secrets on the client workload, thereby enhancing security by reducing the potential exposure of sensitive credentials.

In some embodiments, the method may comprise examining its set of access policies once the client workload is authenticated. In some cases, the method may comprise determining if the client workload is allowed access to the service workload. In some instances, the method may comprise the access policy using the attestation information during the access decision process.

In some cases, the method may comprise identifying a container instance as a fine-grained identity or perform a regular expression match on the namespace for group type policies. In further instances, the method may comprise the server workload being identified by uniform resource identifier or by part of the uniform resource locator for application programming interface access). For example, the method may comprise determining the service account or role that the client workload is authorized to log into based on the access policy. In further examples, this service account or role can be configured into the Access Credential, offering a higher level of security and flexibility in controlling access.

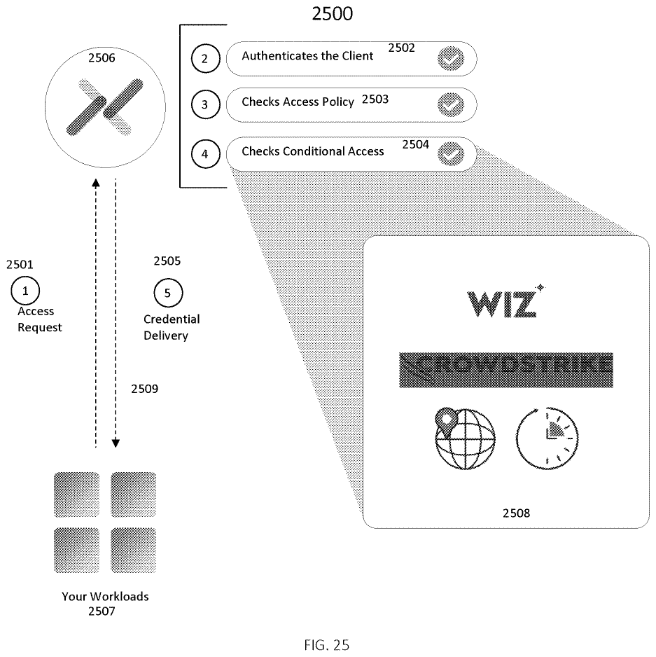

FIG. 25 shows an example of a detailed view of a system architecture conditional access functionality 2500. In some embodiments, the conditional access provider 2506 may receive an access request 2501 from managed workloads 2507. In some cases, the condition access provider 2506 may perform a series of checks. In some cases, the series of checks may comprise authenticating the client 2502, checking the access policy 2503, and checking conditional access 2504. In some instances, the conditional access provider 2506 retrieves dynamic data from external sources such as CrowdStrike & Wiz 2508. For example, once these checks are successfully completed, the conditional access provider 2506 may provide an access decision 2505 and deliver 2509 to the managed workloads 2507. As an example, the system may dynamically manage access based on real-time assessment of various conditions associated with the workload's posture.

In some embodiments, the method may comprise managing access between workloads and services by supporting conditions beyond the verification of the correct client workload accessing the right services. In some cases, the method may comprise using the system service to query external security services like CrowdStrike or Wiz to determine the risk profile of the Virtual Machine (VM) or the health of the Kubernetes Cluster. In some instances, the method may comprise applying conditional access dependent on the information from the client workload, such as the IP address, or based on contextual factors such as time of day or geographic location. For example, the method may comprise embedding access conditions in the access credential, allowing the service to enforce a downstream conditional access check. In further examples, the method may comprise augmenting the access credential with a conditional access policy about IP addresses to enhance the security of the system.

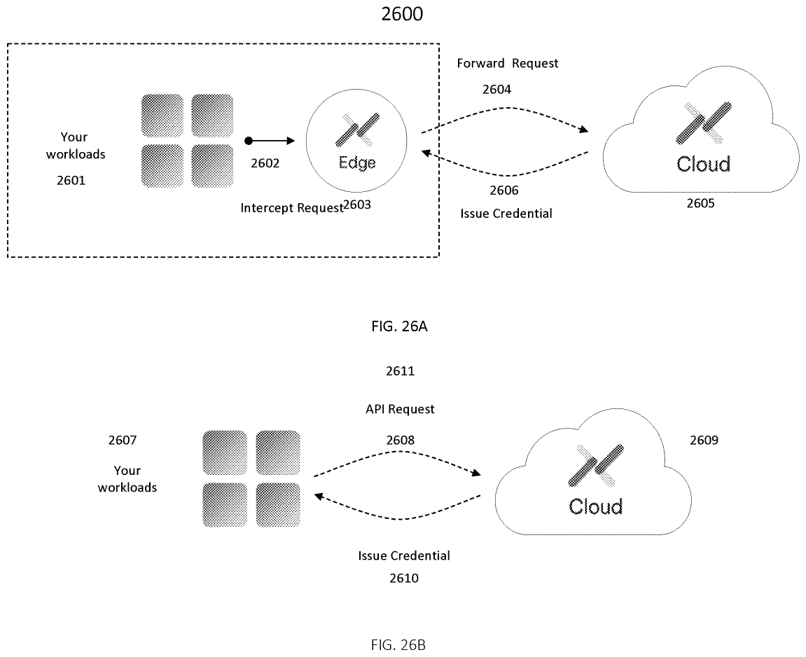

FIG. 26A and FIG. 26B shows an example of different views of the overall system architecture, demonstrating two approaches to managing workload identity and access within the system.

FIG. 26A shows an example of the functionality 2600 of the system cloud. In some embodiments, the system cloud 2604 may function as a sidecar in Kubernetes or Lambda environments, or as an agent in Virtual Machines, providing no-code authentication and protecting credentials from direct access by the workload. The process may begin with managed workloads 2601 initiating an access request. In some cases, the system cloud 2603 may intercept and forward 2604 the access request to a cloud service 2605. In some instances, the cloud service then issues a suitable credential 2606 back to system cloud 2603. For example, the system cloud 2604 may manage access requests and communicate with cloud services to ensure secure and efficient access management.

FIG. 26B shows an example of the method of application programming interface Integration 2611. The process may comprise managed workloads 2607, representing server-based or serverless tasks, sending an application programming interface request 2608 directly to a cloud service 2609. The cloud service may then issue the required credential directly back to managed workloads 2607. As an example the setup may configure direct interaction between the workload and the service and may be used where the proxy does not meet requirements.

In some embodiments, the system comprises at least one mechanism for client workload to authenticate to the system's service. In some cases, the at least one mechanism comprises a plug-in. In some instances, the plug-in comprises code added at the beginning of the client workload, which runs when the client workload runs. For example, the plug-in may request the attestation token, sends it to the system's service, and then assigns the returned access credential to an environment variable.

In some cases, the at least one mechanism may comprise a function variant akin to a plug-in ensuring secure and efficient operation. In some instances, the function variant may be activated whenever an access credential is required. For example, the function variant may establish a handshake with the system's service when the previously returned access credential expires. As an example, the procedure may keep the access credential valid and current, thereby strengthening the security of the system.

In some embodiments, the at least one mechanism may be configured to provide no-code authentication. In some cases, the at least one mechanism may comprise a system cloud. In some instances, the system cloud may comprise a transparent client-side proxy. In some instances, the transparent client-side proxy may allow client workloads to use system-generated credentials with no code changes. For example, the at least one mechanism may be programmed to perform functions such as querying the system's service for the access credential and injecting it directly into the transaction. In further examples, the at least one mechanism may be configured to replace long-lived credentials with short-lived ones without requiring any code modifications. As an example, the functionality of the at least one mechanism may provide system security and efficiency, and is compatible with new code, existing code, and third-party code.

In some embodiments, the system comprises at least one mechanism for transport layer security (TLS) intercept to work with the appropriate root certificate deployed on the client workload. In some cases, the transport layer security mechanism comprises a constrained public key issued to individual client workloads by the system. In some instances, the system cloud may comprise a client-side proxy with a nearly one-to-one relationship with the client workload. In some cases, the system cloud may comprise an application-aware component, injecting a layer 7 application access credential. For example, the system may be configured to use a multi-layer approach to support a wide variety of services, ensuring a secure and efficient identity and access management process.

In some embodiments, the system may comprise an authentication proxy mechanism. In some cases, the authentication proxy mechanism may serve as a proxy for both transmission control protocol and hypertext transfer protocol, with and without transport layer security. In some cases, the system's service supports multiple credential types, including long-lived usernames/passwords, application programming interface keys, OpenID Connect tokens, signed JSON web tokens, and Open Authorization tokens from federated services. In some instances, the authentication proxy mechanism is configured to flexibly dictate how the credential should be incorporated into the stream and how any existing deprecated credential should be eliminated. For instance, the authentication proxy mechanism contributes to secure management and improved of the authentication process by dynamically accommodating multiple credential types and ensuring the safe disposal of deprecated credentials.

In some embodiments, the system comprises at least one comprehensive end-to-end logging feature provided by the system's service. In some cases, this feature comprises logs providing the enterprise to respond to forensic needs by providing precise information about which instance of a client workload accessed which service, at what time, and from where. In some instances, the logs comprise a tool for assisting in debugging operations of an application by providing fine-grained real-time information about access patterns, and successful and failed accesses. For example, the logs may be configured to assist with the discovery of access patterns and guide the admin through a policy definition process via a policy advisor process. As an example, the comprehensive logging feature may securely manage workload identity and access, and provide insights for debugging, and facilitate effective policy definitions.

In some embodiments, the system may comprise a decentralized policy management module. In some cases, the decentralized policy management module may support the setting of access policies by individual application groups. In some instances, the decentralized policy management module may be configured for policy management by allowing application groups to manage access policies for the applications under their purview. In some instances, these policies could be developed by the application team, chosen from policy templates configured by the Chief Information Security Officer (CISO), or may require approval from the CISO before activation, bolstering the system's security and integrity. For example, the decentralized policy management module may allow the system to manage policies through resource sets, subsets of the overall namespace in an organization, where different admins may have access to different sets. In further examples, the decentralization of policy management may allow a personalized and efficient management of workload identity and access within an organization.

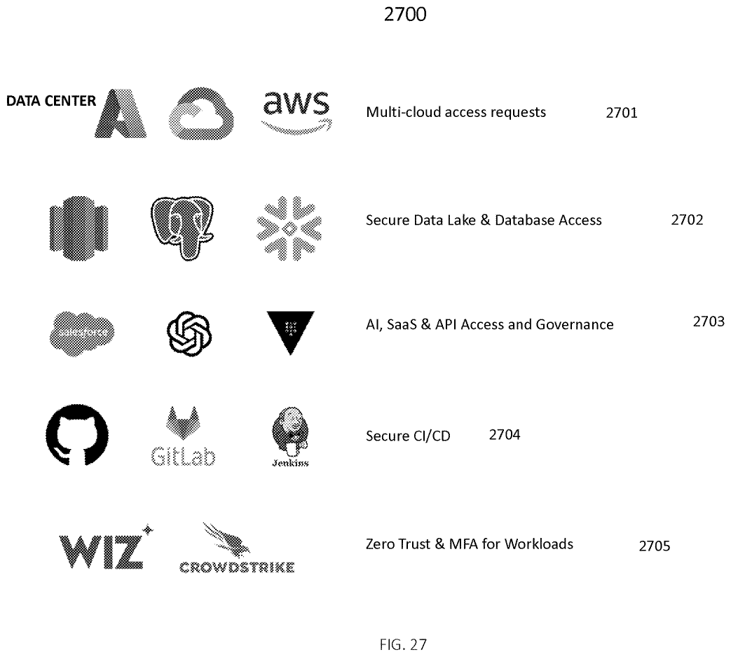

FIG. 27 showcases various scenarios where the workload identity and access management system (2700) may be utilized. In some cases, the system 2700 may be utilized in data center multi-cloud access requests (2701), secure data lake & database access (2702), AI, SaaS & application programming interface access and governance (2703), secure CI/CD (2704), and zero trust & multi-factor authentication for workloads (2705). For instance, in the context of secure data lake & database access, the system (2700) may ensure that only authorized workloads can access the necessary data. Additionally, in implementing zero trust & multi-factor authentication for workloads, the system may securitize access management. In further examples, the system may be configured for any environment requiring secure and efficient workload identity and access management.

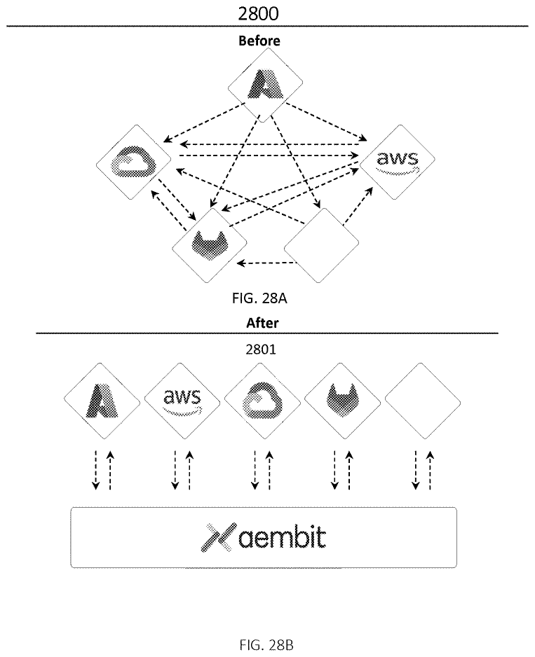

FIG. 28A presents an example of a scenario prior to implementing the workload identity and access management system (2800). The depicted scenario may represent a complex 1:1 identity federation that may pose management challenges due to individual relationships between each pair of interacting entities. Additionally, the lack of conditional access in this setup may reduce the ability of access policies to account for dynamic factors related to the workload or its environment. For example, the distributed auditing represented in FIG. 28A signifies the challenges of aggregating and analyzing access logs from across the system prior to the implementation of the workload identity and access management system.

FIG. 28B shows an example of improved in the access management process following the implementation of the workload identity and access management system (2801). In some embodiments, the system comprises a one-time setup per resource configured to streamline identity federation by reducing the complexity associated with managing individual relationships between each pair of interacting entities. In some cases, the system may be configured for centralized control, conditional access, and centralized auditing features. In some instances, the system may be configured for centralized auditing. For example, the system may boost efficiency, flexibility, and security of access management by streamlining the tracking, monitoring, and analysis of all access events within the system.

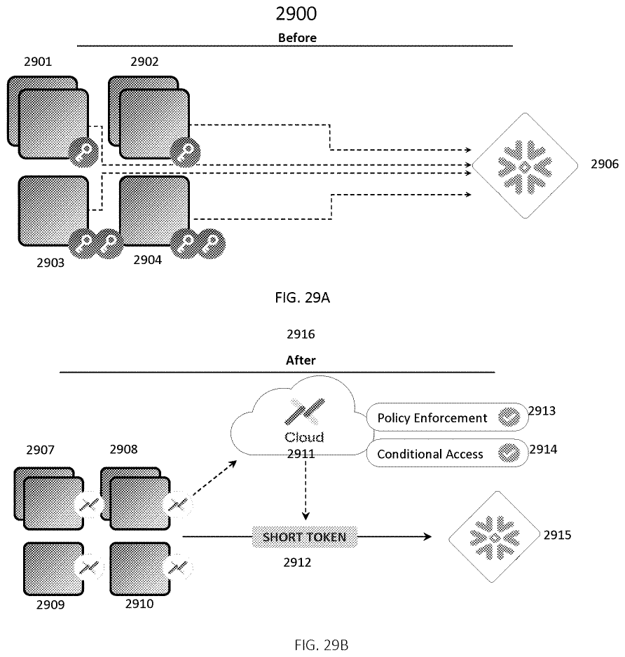

FIG. 29A shows the traditional method for accessing secure storage systems (2900) prior to the implementation of the identity and access management system. This conventional process comprises various client workloads, including virtual machine (2901), serverless (2902), cloud (2903), and on-premises instances (2904), directly accessing a database system like Snowflake (2906) using long-lived credentials stored on the client workloads themselves. This method, characterized by manual synchronization of credentials by administrators and lack of multi-factor authentication, highlights the challenges and security risks inherent in access management without an effective identity and access management system.

FIG. 29B shows a method for accessing secure storage systems (2916) after the implementation of the advanced Identity and Access Management (IAM) system. In some embodiments, the system cloud (2911) connects to a plurality of workload types (e.g., such as virtual machine (2907), serverless (2908), cloud (2909), and on-premises instances (2910)). In some cases, the system cloud (2911) conducts policy enforcement (2913) and conditional access (2914) checks. In some instances, upon successful verification, the system issues a short-lived token (2912) that is dynamically injected into the client workload. For example, the token may then be used by the workload to access a database system like Snowflake (2915). In some embodiments, the system offers enhanced security and control by removing the need for long-lived credentials on client workloads and doing away with manual secrets management. In some cases, the system implements a refined process that notably features policy enforcement, conditional access akin to multi-factor authentication, and the use of dynamically injected short tokens.

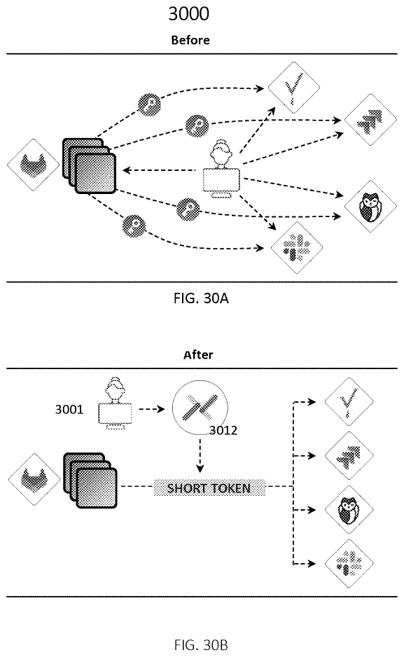

FIG. 30A shows an example of the state of interactions between GitLab and third-party services prior to the deployment of the workload identity and access management system (3000). In this initial state, integrations mandate manual configuration, and the authentication method is tied to static credentials or three-legged Open Authorization specific to a user. Moreover, it lacks a system for per-pipeline access control, underscoring the limitations in setting individual access policies for each pipeline in the existing setup.

FIG. 30B shows an example of the improved state of interactions between GitLab and third-party services following the deployment of the workload identity and access management system (3001). In some embodiments, the system comprises at least one pipeline access controller. In some cases, the at least one pipeline access controller comprises at least one credential provision module. In some instances, the at least one credential provision module comprises an automated mechanism for generating and providing secretless credentials for each pipeline. In some cases, the at least one pipeline access controller comprises at least one policy enforcement module. In some instances, the at least one policy enforcement module comprises a feature to enforce a specific access policy for each pipeline. For example, the at least one pipeline access controller may be configured to diminish the administrative burden and mitigate the risk of human error by automating the management of credentials. In further examples, the system is configured to bolster control over access permissions and elevate the security and efficiency of the overall access management process.

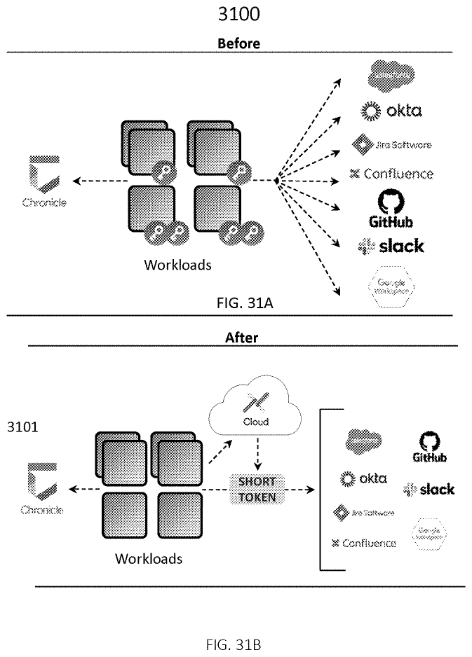

FIG. 31A shows an example of managing access to logs prior to the deployment of the workload identity and access management system (3100). In this initial setup, long-lived secrets are utilized for authentication, and developers are granted direct access to these secrets. Also, the setup lacks a system to authenticate the identity of the application accessing the logs and requires manual rotation of these secrets. This state of affairs underscores potential risks of inconsistency and human error in the access management process without the implementation of an effective workload identity and access management system.

FIG. 31B shows an example of an enhanced scenario for log access management following the deployment of the workload identity and access management system 3101. In some embodiments, the system comprises at least one ephemeral credential adapter. In some cases, the at least one ephemeral credential adapter is configured to reduce security risks associated with long-lived secret keys. In some instances, the system may comprise policy-based access management. Additionally, the system may enforce conditional access policies that consider factors like geographical location and time. Furthermore, the system may provide end-to-end logging, creating a comprehensive audit trail of all access attempts. For example, the system may be configured to elevate the security of log access by incorporating real-time conditions. In further examples, the system is configured to boost control over access permissions and enhance the overall efficiency of the access management process.

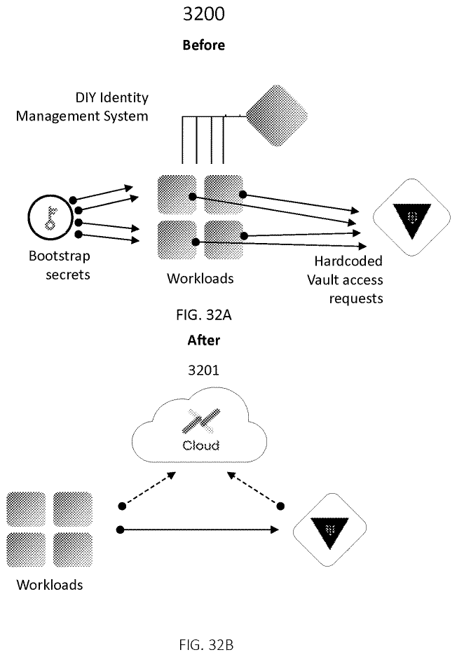

FIG. 32A shows an example of the state of workload enrollment prior to the implementation of the workload identity and access management system (3200). In this state, workload enrollment may depend on a bootstrap secret, and access to the Vault could require coding within the application by the developer. Moreover, the setup might involve a custom-built, complex system for workload identification, lacking Conditional Access. This state underscores the complexity and potential security risks inherent in a manual and code-based access management process without an effective workload identity and access management system.

FIG. 32B shows an example of the improved process for workload enrollment after implementing the Workload Identity and Access Management System (3201). In some embodiments, the system comprises at least one workload enrollment module. In some cases, the at least one workload enrollment module comprises at least one identification component. In some instances, the at least one identification component comprises a mechanism for secretless identification and enrollment, eliminating the need for bootstrap secrets. In some cases, the at least one workload enrollment module comprises at least one authentication component. In some instances, the at least one authentication component comprises a no-code authentication method for Vault access, simplifying the process and reducing the need for developer intervention. For example, the at least one workload enrollment module may be configured to support the implementation of Conditional Access policies. In further examples, the system is configured to enhance security by considering real-time conditions and simplifies the process for workload enrollment, thereby reducing administrative burden and potential security risks.

In some embodiments, the system comprises at least one multi-availability zone (AZ) deployment mechanism that provides high availability and automatic failover for the system. In some cases, the mechanism comprises at least one replicated and monitored service, such as databases and key-management systems, ensuring continuous operation. In some instances, the mechanism includes automated backups across multiple regions, providing data integrity and fast disaster recovery. For example, the system may be configured to adjust resources dynamically based on demand through elastic scaling. In further examples, the system's microservices architecture allows individual services to scale independently, enhancing flexibility and performance. The system may comprise Infrastructure as Code (IaC) and CI/CD pipelines, allowing for consistent, version-controlled infrastructure deployments. Lastly, the system includes centralized logging and monitoring for real-time monitoring and historical analysis, contributing to faster issue resolution.

In some embodiments, the system comprises at least one Augmented Workload Identity and Access Management Controller. In some cases, the controller integrates with HashiCorp Vault to enhance its functionalities. In some instances, the controller comprises at least one module that solves the “secret zero” problem, establishing identity for new devices without a pre-existing secret.

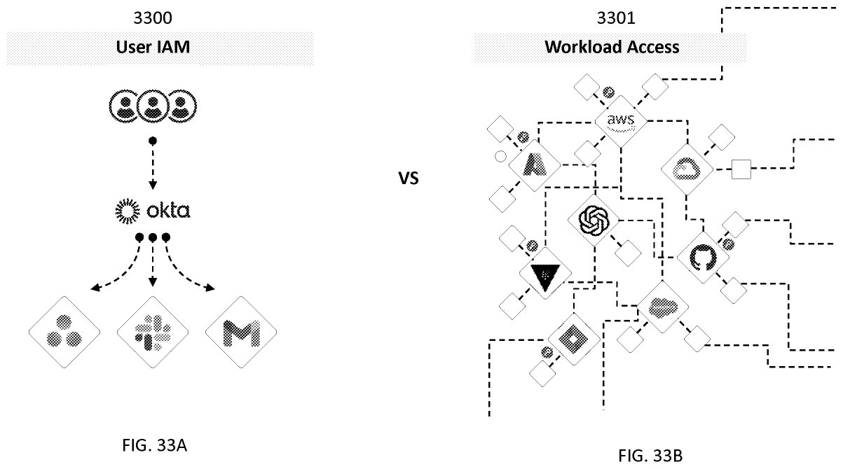

FIG. 33A shows an example of the employment of a popular Identity and Access Management (IAM) tool in a user IAM scenario (3300) prior to the deployment of the workload identity and access management system. In this context, the IAM tool provides secure, user-friendly, and centralized management of user identities and their access to various resources. This state represents effective management of user identities and their access in a secure, centralized manner within a business context.

FIG. 33B shows an example of the improved process for managing workload access within the context of the implemented Workload Identity and Access Management System (3301). In some embodiments, the system comprises at least one workload identity management module. In some cases, the at least one workload identity management module comprises at least one access control component. In some instances, the at least one access control component is responsible for managing the identity and access of workloads, which are automated processes or applications within the system. In some cases, the at least one workload identity management module may be configured to secure and manage the access of workloads to various resources without incorporating a specific Identity and Access Management (IAM) tool. For example, the at least one workload identity management module may be configured to provide robust solutions for securing and managing the access of workloads to various resources, effectively catering to different needs and requirements for managing access for users and workloads within a business environment. In some embodiments, the system comprises at least one Automated Workload Identity and Access Management Controller. In some cases, the controller is configured to eliminate the use of secrets for securing workload access, similar to the function of Okta but tailored specifically for workloads. In some instances, the controller recognizes the growing risk associated with the increasing number of workloads, which can potentially outnumber users by a tenfold. For example, the controller may enhance security measures, implementing mechanisms to effectively manage and secure access among a large quantity of workloads. As an example, the controller may enhance security and contribute to the efficient management of complex interactions within a distributed application environment.

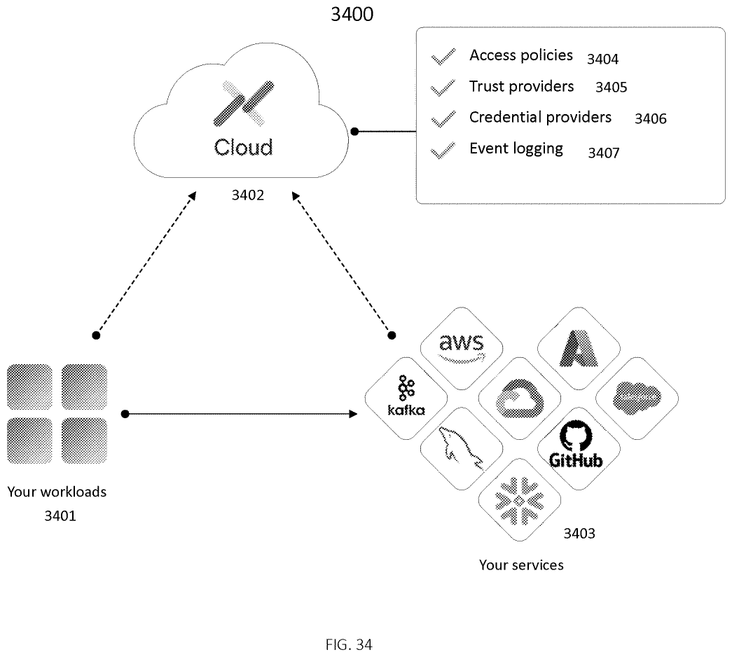

FIG. 34 shows an example of the system operating as a universal workload identity provider (IdP) (3400). In some embodiments, the system comprises at least one cloud component (3402). In some cases, the at least one cloud component comprises at least one access policy module (3404). In some instances, the at least one access policy module may be configured to control and manage access requests from managed workloads (3401). In some cases, the at least one cloud component comprises at least one trust provider module (3405), one credential provider module (3406), and one event logging module (3407). In some instances, these modules may be configured to authenticate workloads, issue credentials, and log access metadata, respectively. For example, the at least one cloud component may be configured to provide a complete audit trail of all access attempts and events (3407) while maintaining the privacy and integrity of workload data. In further examples, the system is configured to offer robust, secure, and efficient workload identity and access management across diverse and distributed digital ecosystems.

In some embodiments, the system comprises at least one access and identity management mechanism. In some cases, this mechanism is distinct from traditional methods involving the use of static secrets. In some instances, the access and identity management mechanism comprises a secretless access feature that offers dynamic credentials, thereby reducing the attack surface. In some cases, the system comprises a policy enforcement module that provides identity-driven, policy-based access control, thereby enhancing security and control. For example, the system may be configured to provide centralized visibility and logging, which can accelerate audit processes and compliance efforts. In further examples, the system ensures controlled and authorized access between apps, enhancing the security of the overall access management process compared to traditional methods of ungoverned access.

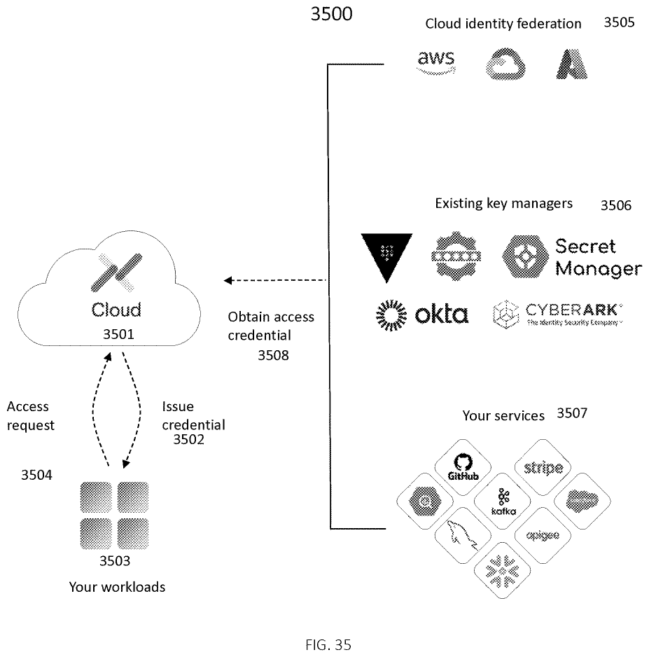

FIG. 35 shows an example of the credential providers in the system (3500). In some embodiments, the system comprises at least one workload identity and access management controller. In some cases, the at least one controller comprises at least one credential request module. In some instances, the at least one credential request module (3504) comprises an automated mechanism for sending access requests to either Cloud Identity Federation (3505) or Existing Key Managers (3506). In some cases, the at least one controller comprises at least one credential provision module. In some instances, the at least one credential provision module is configured to obtain an Access Credential (3508) based on the access request. For example, the at least one controller may be configured to receive the access request from Managed Workloads (3503), dynamically select the best credential provider, obtain the necessary Access Credential (3508), and provide these credentials to the workload for accessing ‘Your Services’ (3507). In further examples, the system (3500) is configured to enhance the flexibility and security of access management by dynamically choosing the best Credential Provider based on the service being accessed.

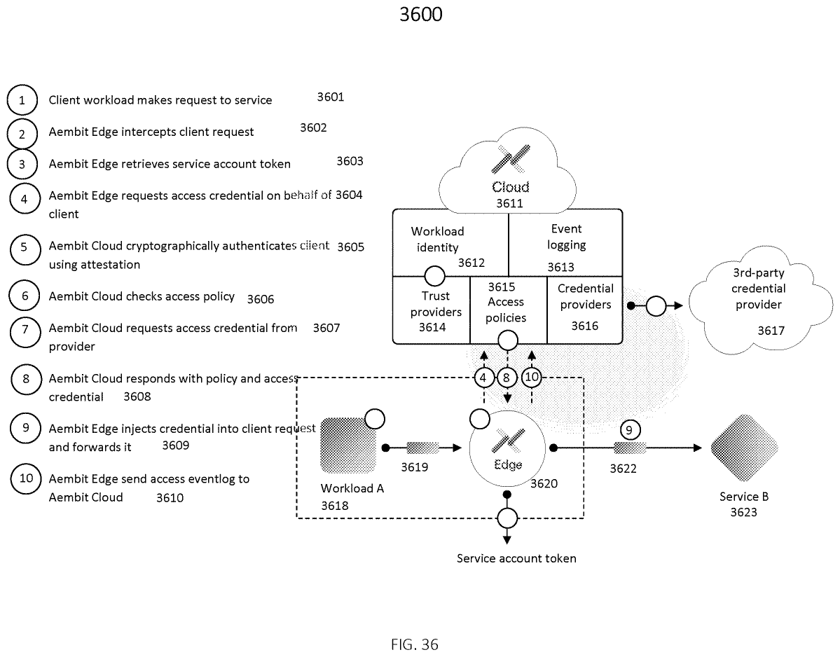

FIG. 36 shows an example of the role and operation of trust providers within the system (3600). In some embodiments, the system comprises at least one workload identity and access management system (3600). In some cases, the at least one system (3600) comprises at least one edge component (3620). In some instances, the at least one edge component (3620) is configured to intercept access requests from a Client Workload (3618) and retrieve a Service Account Token (3621). In some cases, the at least one system (3600) comprises at least one Cloud Component (3611). In some instances, the at least one Cloud Component (3611) comprises an Attestation Method (3612) for cryptographically authenticating the client, and a mechanism to check Access Policies (3615). For example, the system (3600) may be configured to request an access credential from the appropriate provider based on the authenticated client and the checked access policy. In further examples, the system is configured to provide secretless authentication, verify workload identities, enforce access policies, handle credentials, and log access events, thereby enhancing the security and efficiency of workload access management.

The present disclosure may provide a method for secure and efficient workload access management is provided. In some embodiments, the method comprises the initiation of an access request (3601) by a client workload. In some cases, this access request (3601) is intercepted (3602) by a system's edge component. In some instances, the edge component retrieves a service account token (3603) and requests an access credential on behalf of the client workload (3604). Additionally, the method may involve the transmission of this request to a cloud component of a system. In further instances, the cloud component cryptographically authenticates the client workload using an attestation process (3605), checks the access policy (3606), and requests an access credential from the provider (3607). For example, the method may involve the generation and delivery of access credentials to the client workload based on the response with policy and access credential (3608) from the cloud component. In further examples, the method may involve the edge component injecting the credential into the client request and forwarding it (3609), and subsequently sending an access event log to the cloud component (3610). This method enhances the security and efficiency of managing access between a workload and a service by ensuring that only authenticated and approved workloads can access the services they need.

In some embodiments, the system comprises at least one workload identity and access management controller. In some cases, the at least one controller comprises at least one trust provider module. In some instances, the at least one trust provider module comprises a selection of services from which cryptographically signed identity documents can be retrieved. In some cases, the at least one controller comprises at least one federation module. In some instances, the at least one federation module comprises the capability to seamlessly integrate with various services for efficient management of workload identity and access. For example, the at least one controller may be configured to authenticate workloads via a secretless approach, eliminating the need for shared secrets. In further examples, the system operates to provide a comprehensive overview of the functions and integrations of its Trust Providers, demonstrating its ability to offer secure, efficient, and secretless workload authentication.

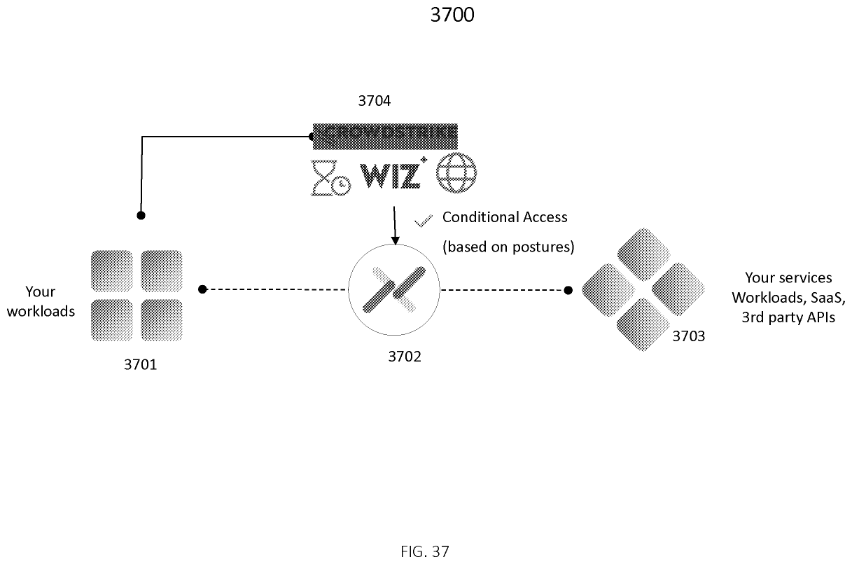

FIG. 37 shows an example of a workflow of the system granting conditional access 3702.

In some embodiments, the system comprises at least one IAM system. In some cases, the at least one IAM system comprises at least one access management module (3702). In some instances, the at least one access management module is configured to grant conditional access to workloads (3701). In some cases, the at least one IAM system interacts with various services, workloads, SaaS, and 3rd party application programming interfaces (3703). In some instances, the at least one IAM system interacts with security technology providers such as CrowdStrike (3704). For example, the at least one IAM system may be configured to grant conditional access based on specific postures. In further examples, the interaction between the IAM system, the workloads, and security technology providers such as CrowdStrike provides a secure and efficient access management solution.

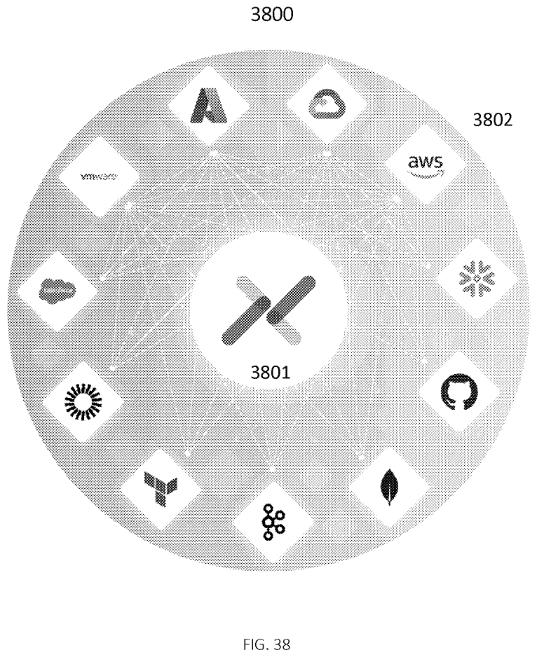

FIG. 38 shows an example of Implementation and Use Cases of a Control Plane in a Workload Communication and Access Management System (3800). In some embodiments, the system (3800) comprises at least one control plane (3801) configured to manage all communication in an automated fashion. In some cases, the at least one control plane (3801) comprises at least one access management module. In some instances, the access management module is capable of managing access across diverse environments like Multi-cloud, Datacenter, Cloud application programming interfaces, and SaaS. In some cases, the at least one control plane (3801) comprises at least one policy-based authentication module. In some instances, this policy-based authentication module eliminates the need for human intervention in handling machine credentials. For example, the at least one control plane (3801) may be configured to remove authentication concerns from developers, aligning with DevOps automation. In further examples, the system (3800) is configured to enhance visibility and compliance for sensitive workloads, thereby aiding in governance and securely and efficiently managing access between workloads across diverse environments. This configures the system (3800) to address the increasing workload-to-workload attack surface, remove the IAM bottleneck in workflows, and accelerate the transition towards secretless access and zero trust.

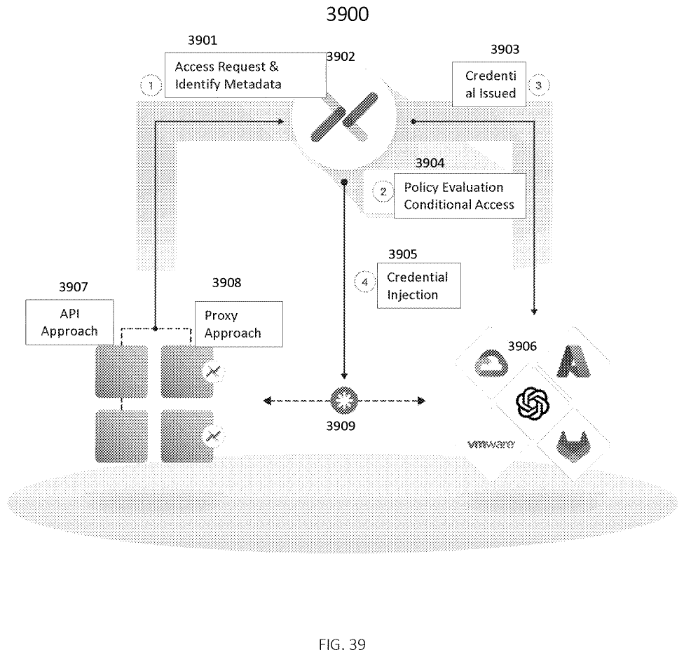

FIG. 39 shows an example of a secure access management between workloads and services 3900. In some embodiments, the system comprises at least one access management module (3902). In some cases, the at least one access management module comprises at least one credential request module (3901). In some instances, the at least one credential request module is configured to send an ‘Access Request & Identify Metadata’ to the system. In some cases, the at least one access management module comprises at least one policy evaluation module (3904). In some instances, the policy evaluation module is configured to conduct ‘Policy Evaluation & Conditional Access’ based on predefined access policies and real-time conditions. For example, the at least one access management module may be configured to issue credentials (3903) and inject these credentials into the client workload during the ‘Credential Injection’ phase (3905). In further examples, the system is configured to connect with the ‘Applications’ (3906) via the ‘application programming interface Approach’ (3907) and the ‘Proxy Approach’ (3908) through a ‘Connector’(3909), which receives the injected credentials from the system. This configuration provides a comprehensive approach to securely managing access between workloads and services.

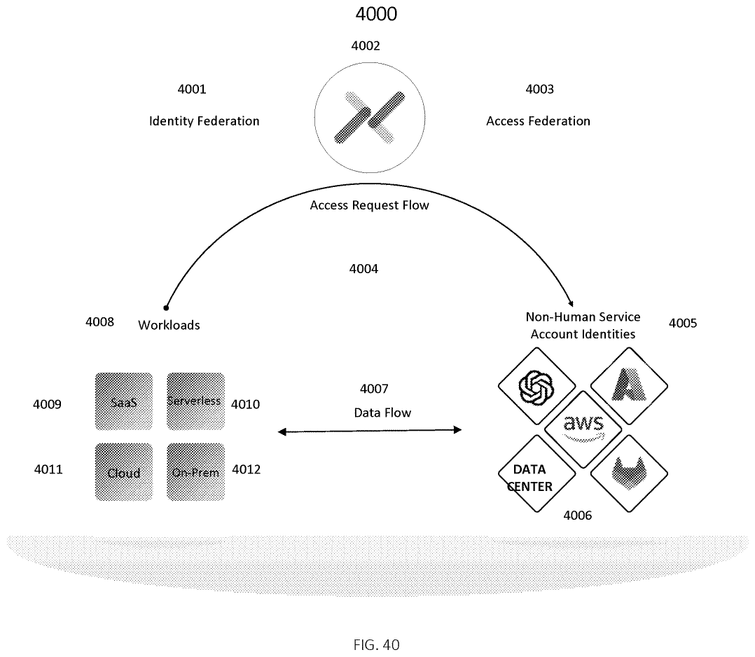

FIG. 40 shows an example of a system that manages access in a distributed environment by interfacing with Identity and Access Federation Services (4000). In some embodiments, the system comprises at least one access management module (4002). In some cases, the at least one access management module interfaces with ‘Identity Federation’ services (4001). In some instances, the at least one access management module also interfaces with ‘Access Federation’ services (4003). In some cases, the at least one access management module is configured to receive ‘Access Request Flow’ (4004) initiated by various ‘Workloads’ (4008). In some instances, this ‘Access Request Flow’ is directed towards ‘Non-Human Service Account Identities’ (4005). For example, the at least one access management module may be configured to handle the authentication process, check the access policies, and provide necessary access credentials. In further examples, the system is configured to manage the ‘Data Flow’ phase (4007) where the workload is granted access to the requested service, thereby securely managing workload identity and access in a distributed environment.

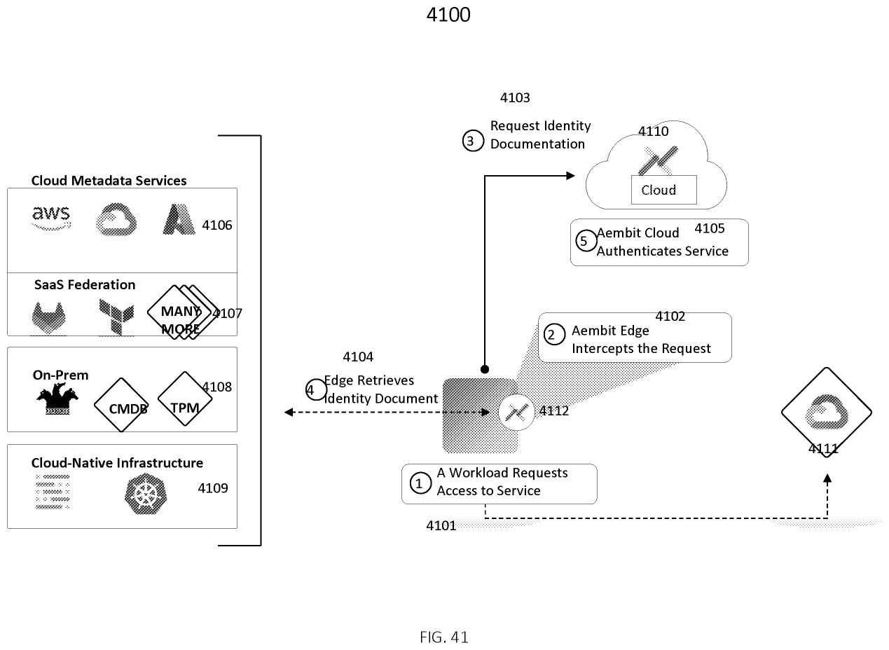

FIG. 41 shows an example of a system that utilizes trust providers to manage and secure access within its environment (4100). In some embodiments, the system comprises at least one identity verification module. In some cases, the at least one identity verification module comprises at least one request module. In some instances, the at least one request module intercepts access requests to a service (4101) and sends a request for identity documentation (4103). In some cases, the at least one identity verification module comprises at least one retrieval module. In some instances, the retrieval module can fetch identity documentation from a range of Trust Providers including Cloud-Native Infrastructure (4104), Cloud Metadata Services (4106), SaaS Federation (4107), On-Prem systems (4108), and additional Cloud-Native Infrastructure (4109). For example, the identity verification module uses the retrieved Identity Document (4105) to verify the identity of the requesting workload. In further examples, the system operates within a cloud-based environment (4110) and can authenticate workloads securely by retrieving and verifying identity documents from various Trust Providers across diverse environments.

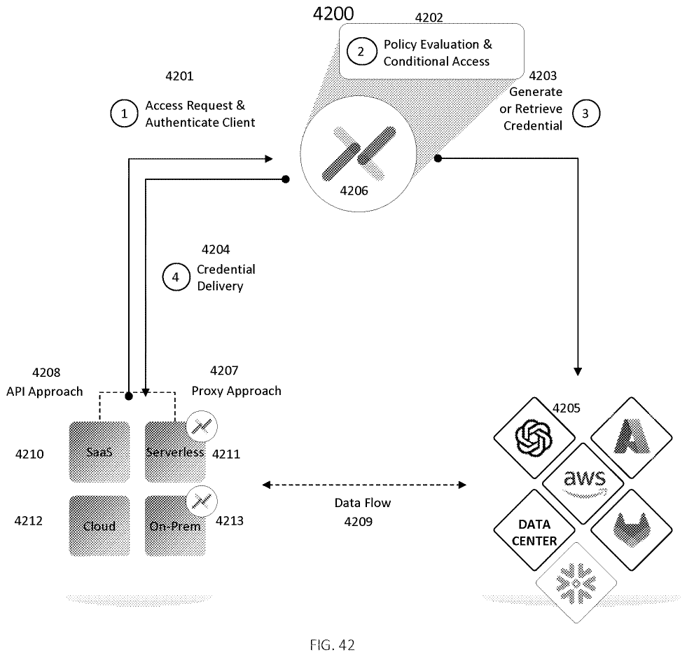

FIG. 42 shows an example of a universal workload identity broker system architecture 4200. In some embodiments, the system comprises at least one Universal Workload Identity Broker System Architecture (4200). In some cases, the at least one system architecture comprises at least one client authentication module. In some instances, the client authentication module is configured to provide secretless client authentication via attestation. In some cases, the at least one system architecture comprises at least one policy evaluation module. In some instances, the policy evaluation module is configured to offer policy-based access supplemented with conditional access. In some cases, the at least one system architecture comprises a credential management module that interacts with a data center/various applications such as cloud-based chat applications (4205). For example, the at least one system architecture may be configured to operate on the control plane, log access metadata, offer no-code authentication, and allow for automated deployment and scaling. In further examples, the system architecture handles the ‘Access Request & Authenticate Client’ (4201), manages the ‘Policy Evaluation & Conditional Access’ phase (4202), operates the ‘Generate or Retrieve Credential’ phase (4203), conducts the ‘Credential Delivery’ phase (4204), and operates in various environments such as ‘SaaS’ (4210), ‘Serverless’ (4211), ‘Cloud’ (4212), and ‘On-Prem’ (4213).

In some cases, the platform may comprise a service workload component alongside the service workload. The service workload component may help the service workload validate the access credential coming from the client workload, and return to the service the authorizations associated with the client workload. This service workload component is analogous to the client workload proxy, but instead of acquiring and injecting the access credential on behalf of the client workload, the service workload component processes the access credential to determine the authorizations of the client workload.

In an aspect, disclosed herein a method of securing access between workloads, comprising: receiving a request from a client workload to access a service workload; authenticating the client workload based at least in part on identifying information determined from a compute environment of the client workload; retrieving an access policy based at least in part on the client workload identity; generating or retrieving an access credential to access the service workload based at least in part on the access policy; and communicating data between the workload and the service based at least in part on the access credential.

In some embodiments, the method comprises logging access events in a database. In some embodiments, the method comprises authenticating the identity of the client workload comprises using a federated approach to interface with the client workload's environment.

In some embodiments, the authenticating the identity of the client workload comprises: receiving an authentication token comprising the identifying information that is signed by a private key that is associated with the compute environment; verifying the authentication token using a public key that is associated with the private key; and providing a signal indicating that the client workload has been verified after the authentication token has been verified. In some embodiments, the retrieving the access policy comprises determining a match between the attestation token and information about the service workload. In some embodiments, the access policy allows group type policies through regular expression matching on a namespace. In some embodiments, the access policy is retrieved from a centralized policy database managed by an identity and access management system. In some embodiments, the access credential is a short-lived token. In some embodiments, the method comprises generating the access credential as a minted token through a trust relationship between the service workload and a federated system. In some embodiments, the minted token corresponds to a service account or a role, or includes claims specifying the client workload's rights at the service. In some embodiments, the access credential is obtained from software as a service (Saas) service being accessed, configured to trust requests from a federated system and return tokens for access. In some embodiments, the method comprises requesting tokens from federated cloud services for access to services within a cloud, with the cloud services configured to trust requests from the federated system.

In some embodiments, the long-lived credentials like username, passwords, and application programming interface keys are supported, which are either stored within a federated system or requested from a secrets manager specified by the enterprise. In some embodiments, the method comprises implementing a two-sided federation architecture comprising trust relationships for trust providers and credential providers between a federated system, a compute environment, and a service workload or a cloud's federation service. In some embodiments, the two-sided federation architecture aids in generation or retrieval of the access credential. In some embodiments, the access credential is delivered just-in-time to the client workload upon satisfaction of the access policy, providing timely access. In some embodiments, the method comprises providing conditional access based on policies that impose conditions beyond verification of correct client workload accessing correct service. In some embodiments, the conditional access comprises confirming a posture or configuration of the client workload by querying external risk assessment entities like CrowdStrike Falcon or Wiz for risk information, using the workload identity. In some embodiments, the conditional access depends on information from the client workload, such as an IP address of the client workload. In some embodiments, the conditional access is contextual, including time of day restrictions on access policies, geographic restrictions, or both. In some embodiments, the conditional access policies serve as multi-factor authentication (MFA) for workload, to enhance a cryptographic identity in making an access decision. In some embodiments, a context of conditional access policies hardens the authentication, such that a service account token delivered from an untrusted environment will not be trusted. In some embodiments, some access conditions may be embedded in an access credential, allowing the service to enforce a downstream conditional access check. In some embodiments, the access credential is augmented with a conditional access policy about IP addresses, so the access credential can only be used by clients in specified IP address ranges, preventing misuse of the access credential by rogue clients outside of the expected environment.

In another aspect, disclosed herein are methods for managing access between workloads, comprising: (a) intercepting, by an edge component, a client workload and sending an attestation token about an identity of the client workload and information about a service workload that the client workload is to access to a cloud component; (b) receiving, by the cloud component, the attestation token and generating an access credential based at least in part on the attestation token and an access policy; and (c) injecting, by the edge component, the access credential to the client workload.

In some embodiments, the attestation token is for authenticating then identity of the client workload. In some embodiments, the attestation token is generated based on an identifying information that is signed by a private key that is associated with a compute environment of the client workload. In some embodiments, the cloud component verifies the attestation token using a public key that is associated with the private key. In some embodiments, the cloud component further verifies the attestation token by validating additional fields of the attestation token for enhanced security. In some embodiments, the access credential is a short-lived token. In some embodiments, the method comprises determining a match between the attestation token and information about the service workload. In some embodiments, the access policy comprises conditional access policy. In some embodiments, the conditional access policy comprises factors related to the health and posture of the client workload, and the geographic location or time of an access request.

In yet another aspect, disclosed herein are systems for managing access between workloads, comprising: an edge component configured to: (i) intercept a client workload; (ii) send an attestation token about an identity of the client workload and information about a service workload that the client workload is to access to a cloud component; and the cloud component configured to: (i) receive the attestation token; (ii) generate an access credential based at least in part on the attestation token and an access policy; (iii) and send the access credential to the edge component for injecting into the client workload. In some embodiments, the attestation token is for authenticating then identity of the client workload. In some embodiments, the attestation token is generated based on an identifying information that is signed by a private key that is associated with a compute environment of the client workload. In some embodiments, the cloud component is configured to further verify the attestation token using a public key that is associated with the private key. In some embodiments, the cloud component is configured to further verify the attestation token by validating additional fields of the attestation token for enhanced security. In some embodiments, the access credential is a short-lived token. In some embodiments, the cloud component is configured to further determine a match between the attestation token and information about the service workload. In some embodiments, the access policy comprises conditional access policy. In some embodiments, the conditional access policy comprises factors related to the health and posture of the client workload, and the geographic location or time of an access request.

### Machine Learning

As used herein, the terms “artificial intelligence,” “artificial intelligence techniques,” “artificial intelligence operation,” and “artificial intelligence algorithm” generally refer to any system or computational procedure that may take one or more actions to enhance or maximize a chance of achieving a goal. The term “artificial intelligence” may include “generative modeling,” “machine learning” (ML), or “reinforcement learning” (RL).

As used herein, the terms “machine learning,” “machine learning techniques,” “machine learning operation,” and “machine learning model” generally refer to any system or analytical or statistical procedure that may progressively improve computer performance of a task. In some cases, machine learning may generally involve identifying and recognizing patterns in existing data in order to facilitate making predictions for subsequent data. Machine learning may include a machine learning model (which may include, for example, a machine learning algorithm). Machine learning, whether analytical or statistical in nature, may provide deductive or abductive inference based on real or simulated data. The machine learning model may be a trained model. Machine learning (ML) may comprise one or more supervised, semi-supervised, self-supervised, or unsupervised machine learning techniques. For example, an ML model may be a trained model that is trained through supervised learning (e.g., various parameters are determined as weights or scaling factors). ML may comprise one or more of regression analysis, regularization, classification, dimensionality reduction, ensemble learning, meta learning, association rule learning, cluster analysis, anomaly detection, deep learning, or ultra-deep learning. ML may comprise, but is not limited to: k-means, k-means clustering, k-nearest neighbors, learning vector quantization, linear regression, non-linear regression, least squares regression, partial least squares regression, logistic regression, stepwise regression, multivariate adaptive regression splines, ridge regression, principal component regression, least absolute shrinkage and selection operation, least angle regression, canonical correlation analysis, factor analysis, independent component analysis, linear discriminant analysis, multidimensional scaling, non-negative matrix factorization, principal components analysis, principal coordinates analysis, projection pursuit, Sammon mapping, t-distributed stochastic neighbor embedding, AdaBoosting, boosting, gradient boosting, bootstrap aggregation, ensemble averaging, decision trees, conditional decision trees, boosted decision trees, gradient boosted decision trees, random forests, stacked generalization, Bayesian networks, Bayesian belief networks, naïve Bayes, Gaussian naïve Bayes, multinomial naïve Bayes, hidden Markov models, hierarchical hidden Markov models, support vector machines, encoders, decoders, auto-encoders, stacked auto-encoders, perceptrons, multi-layer perceptrons, artificial neural networks, feedforward neural networks, convolutional neural networks, recurrent neural networks, long short-term memory, deep belief networks, deep Boltzmann machines, deep convolutional neural networks, deep recurrent neural networks, or generative adversarial networks.

Training the machine learning model may include, in some cases, selecting one or more untrained data models to train using a training data set. The selected untrained data models may include any type of untrained machine learning models for supervised, semi-supervised, self-supervised, or unsupervised machine learning. The selected untrained data models be specified based upon input (e.g., user input) specifying relevant parameters to use as predicted variables or other variables to use as potential explanatory variables. For example, the selected untrained data models may be specified to generate an output (e.g., a prediction) based upon the input. Conditions for training the machine learning model from the selected untrained data models may likewise be selected, such as limits on the machine learning model complexity or limits on the machine learning model refinement past a certain point. The machine learning model may be trained (e.g., via a computer system such as a server) using the training data set. In some cases, a first subset of the training data set may be selected to train the machine learning model. The selected untrained data models may then be trained on the first subset of training data set using appropriate machine learning techniques, based upon the type of machine learning model selected and any conditions specified for training the machine learning model. In some cases, due to the processing power requirements of training the machine learning model, the selected untrained data models may be trained using additional computing resources (e.g., cloud computing resources). Such training may continue, in some cases, until at least one aspect of the machine learning model is validated and meets selection criteria to be used as a predictive model.

In some cases, one or more aspects of the machine learning model may be validated using a second subset of the training data set (e.g., distinct from the first subset of the training data set) to determine accuracy and robustness of the machine learning model. Such validation may include applying the machine learning model to the second subset of the training data set to make predictions derived from the second subset of the training data. The machine learning model may then be evaluated to determine whether performance is sufficient based upon the derived predictions. The sufficiency criteria applied to the machine learning model may vary depending upon the size of the training data set available for training, the performance of previous iterations of trained models, or user-specified performance requirements. If the machine learning model does not achieve sufficient performance, additional training may be performed. Additional training may include refinement of the machine learning model or retraining on a different first subset of the training dataset, after which the new machine learning model may again be validated and assessed. When the machine learning model has achieved sufficient performance, in some cases, the machine learning may be stored for present or future use. The machine learning model may be stored as sets of parameter values or weights for analysis of further input (e.g., further relevant parameters to use as further predicted variables, further explanatory variables, further user interaction data, etc.), which may also include analysis logic or indications of model validity in some instances. In some cases, a plurality of machine learning models may be stored for generating predictions under different sets of input data conditions. In some embodiments, the machine learning model may be stored in a database (e.g., associated with server).

In some embodiments, the machine learning may be based on a large language model (LLM). An LLM is a type of AI model configured to understand generate human language. These models are built using deep learning techniques, such as transformers, which configure them to capture complex language patterns and relationships. LLMs are trained on massive amounts of text data, such as books, articles, websites, and more, to learn grammar, syntax, semantics, and even some level of common-sense reasoning. They can generate coherent and contextually relevant text, making them highly versatile for a wide range of language processing tasks.

### Computer Systems

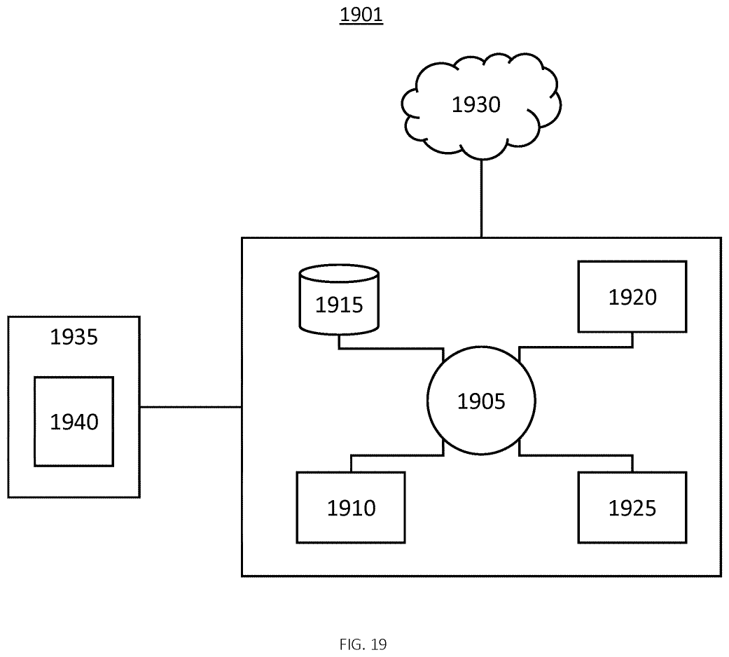

The present disclosure provides computer systems that are programmed to implement methods of the disclosure. FIG. 19 shows a computer system that is programmed or otherwise configured to run workloads, host a proxy, and/or manage identity and access for workloads and/or provide the IAM console as described herein. The computer system 1901 can regulate various aspects of the present disclosure, for example, for communications and logic among the workload system, server, IAM console, and/or services. The computer system 1901 can be an electronic device of a user or a computer system that is remotely located with respect to the electronic device.

The computer system 1901 includes a central processing unit (CPU, also “processor” and “computer processor” herein) 1905, which can be a single core or multi core processor, or a plurality of processors for parallel processing. The computer system 1901 also includes memory or memory location 1910 (e.g., random-access memory, read-only memory, flash memory), electronic storage unit 1915 (e.g., hard disk), communication interface 1920 (e.g., network adapter) for communicating with one or more other systems, and peripheral devices 1925, such as cache, other memory, data storage and/or electronic display adapters. The memory 1910, storage unit 1915, interface 1920 and peripheral devices 1925 are in communication with the CPU 1905 through a communication bus (solid lines), such as a motherboard. The storage unit 1915 can be a data storage unit (or data repository) for storing data. The computer system 1901 can be operatively coupled to a computer network (“network”) 1930 with the aid of the communication interface 1920. The network 1930 can be the Internet, an internet and/or extranet, or an intranet and/or extranet that is in communication with the Internet. The network 1930 in some cases is a telecommunication and/or data network. The network 1930 can include one or more computer servers, which can configure distributed computing, such as cloud computing. The network 1930, in some cases with the aid of the computer system 1901, can implement a peer-to-peer network, which may configure devices coupled to the computer system 1901 to behave as a client or a server.

The CPU 1905 can execute a sequence of machine-readable instructions, which can be embodied in a program or software. The instructions may be stored in a memory location, such as the memory 1910. The instructions can be directed to the CPU 1905, which can subsequently program or otherwise configure the CPU 1905 to implement methods of the present disclosure. Examples of operations performed by the CPU 1905 can include fetch, decode, execute, and writeback.

The CPU 1905 can be part of a circuit, such as an integrated circuit. One or more other components of the system 1901 can be included in the circuit. In some cases, the circuit is an application specific integrated circuit (ASIC).

The storage unit 1915 can store files, such as drivers, libraries, and saved programs. The storage unit 1915 can store user data, e.g., user preferences and user programs. The computer system 1901 in some cases can include one or more additional data storage units that are external to the computer system 1901, such as located on a remote server that is in communication with the computer system 1901 through an intranet or the Internet.

The computer system 1901 can communicate with one or more remote computer systems through the network 1930. For instance, the computer system 1901 can communicate with a remote computer system of a user (e.g., a mobile device). Examples of remote computer systems include personal computers (e.g., portable PC), slate or tablet PC's (e.g., Apple® iPad, Samsung® Galaxy Tab), telephones, smart phones (e.g., Apple® iphone, Android-configured device, Blackberry®), or personal digital assistants. The user can access the computer system 1901 via the network 1930.

Methods as described herein can be implemented by way of machine (e.g., computer processor) executable code stored on an electronic storage location of the computer system 1901, such as, for example, on the memory 1910 or electronic storage unit 1915. The machine executable or machine readable code can be provided in the form of software. During use, the code can be executed by the processor 1905. In some embodiments, the code can be retrieved from the storage unit 1915 and stored on the memory 1910 for ready access by the processor 1905. In some embodiments, the electronic storage unit 1915 can be precluded, and machine-executable instructions are stored on memory 1910.

The code can be pre-compiled and configured for use with a machine having a processer adapted to execute the code, or can be compiled during runtime. The code can be supplied in a programming language that can be selected to configure the code to execute in a pre-compiled or as-compiled fashion.

Aspects of the systems and methods provided herein, such as the computer system 1901, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may configure loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1901 can include or be in communication with an electronic display 1935 that comprises a user interface (UI) 1940 for providing, for example, a dashboard. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1905.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (application programming interfaces), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application (e.g., IAM application). In light of the disclosure provided herein, those of skill in the art will recognize that a web application, in various embodiments, utilizes one or more software frameworks and one or more database systems. In some embodiments, a web application is created upon a software framework such as Microsoft . NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL, and Oracle. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous JavaScript and XML (AJAX), Flash ActionScript, JavaScript, or Silverlight. In some embodiments, a web application is written to some extent in a server-side coding language such as Active Server Pages (ASP), ColdFusion, Perl, Java, JavaServer Pages (JSP), Hypertext Preprocessor (PHP), Python, Ruby, Tcl, Smalltalk, WebDNA, or Groovy. In some embodiments, a web application is written to some extent in a database query language such as Structured Query Language (SQL). In some embodiments, a web application integrates enterprise server products such as IBM Lotus Domino. In some embodiments, a web application includes a media player element. In various further embodiments, a media player element utilizes one or more of many suitable multimedia technologies including, by way of non-limiting examples, Adobe Flash, HTML 5, Apple QuickTime, Microsoft Silverlight, Java, and Unity.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C #, Objective-C, Java, JavaScript, Pascal, Object Pascal, Python, Ruby, VB. NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator, Celsius, Bedrock, Flash Lite, . NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Python, Visual Basic, and VB . NET, or combinations thereof. Compilation is often performed, at least in part, to create an executable program. In some embodiments, a computer program includes one or more executable complied applications.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, image, cell state, protocol, and culture condition information. In various embodiments, suitable databases include, by way of non-limiting examples, relational databases, non-relational databases, object-oriented databases, object databases, entity-relationship model databases, associative databases, XML databases, document-oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based at least in part on one or more local computer storage devices.

While preferred embodiments of the present disclosure have been shown and described herein, it will be obvious to those skilled in the art that such embodiments are provided by way of example only. It is not intended that the present disclosure be limited by the specific examples provided within the specification. While the embodiments of the present disclosure have been described with reference to the aforementioned specification, the descriptions and illustrations of the embodiments herein are not meant to be construed in a limiting sense. Numerous variations, changes, and substitutions will now occur to those skilled in the art without departing from the embodiments of the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the embodiments of the present disclosure. It is therefore contemplated that the present disclosure shall also cover any such alternatives, modifications, variations, or equivalents. It is intended that the following claims define the scope of the invention(s) and that methods and structures within the scope of these claims and their equivalents be covered thereby.

What is claimed is:

1. A method of securing access between workloads, comprising:
a. intercepting, by an edge component, a request from a client workload to access a service workload;
b. authenticating an identity of the client workload based at least in part on identifying information associated with a compute environment in which the client workload executes;
c. retrieving, based at least in part on the authenticated client workload identity, an access policy governing access between the client workload and the service workload;
d. generating or retrieving an access credential for accessing the service workload based at least in part on the access policy; and
e. injecting, by the edge component, the access credential into the request and forwarding the request to the service workload.

2. The method of claim 1, wherein the edge component is configured to intercept the request and inject the access credential without requiring any modification to source code of the client workload.

3. The method of claim 1, wherein the edge component is deployed as a sidecar container within a containerized compute environment in which the client workload executes, or as an agent on a virtual machine on which the client workload executes.

4. The method of claim 1, wherein authenticating the identity of the client workload comprises establishing the identity of the client workload without a pre-existing stored secret, thereby enabling access without requiring the client workload to possess an initial identity credential.

5. The method of claim 1, wherein authenticating the identity of the client workload comprises: receiving an authentication token comprising the identifying information, the authentication token being cryptographically signed by a private key associated with the compute environment, verifying the authentication token using a public key corresponding to the private key; and confirming authentication of the client workload based on the verified authentication token.

6. The method of claim 5, further comprising automating retrieval of the public key from a federated endpoint or metadata service associated with the compute environment.

7. The method of claim 1, further comprising implementing a two-sided federation architecture comprising trust relationships for trust providers and credential providers between a federated system, the compute environment, and the service workload.

8. The method of claim 1, wherein the access policy supports group-type policies through regular expression matching on a namespace, to allow a single policy to govern access by a class of client workloads to a class of service workloads.

9. The method of claim 1, further comprising performing a conditional access evaluation that imposes one or more access conditions beyond verification of the client workload identity.

10. The method of claim 9, wherein performing the conditional access evaluation comprises querying an external security service to obtain a risk profile or health status of the client workload, and providing the access credential only if the risk profile or health status satisfies a threshold.

11. The method of claim 1, wherein the access credential comprises a short-lived token delivered just-in-time to the edge component upon satisfaction of the access policy.

12. The method of claim 11, wherein the short-lived token comprises claims specifying access rights of the client workload at the service workload

13. The method of claim 1, further comprising logging access attempts and associated metadata, including successful and failed attempts, an Internet Protocol (IP) address, and reasons for denial.

14. The method of claim 13, further comprising identifying patterns in the logged information using a discovery service to assist in creating an access policy based on derived insights.

15. The method of claim 1, wherein a conditional access evaluation is contextual, including at least one of a time-of-day restriction or a geographic restriction associated with the access policy.

16. The method of claim 1, further comprising augmenting the access credential with a conditional access policy regarding IP address ranges, to prevent misuse of the access credential by rogue clients.

17. The method of claim 1, further comprising performing transport layer security (TLS) decryption for data communication to permit the edge component to inject the access credential into a secure request.

18. The method of claim 1, further comprising providing a service workload component configured to help the service workload validate the access credential and determine authorizations associated with the client workload.

19. The method of claim 1, wherein the access credential is a short-lived token that replaces a long-lived secret comprising a username and password or an application programming interface (API) key.

20. A system for securing access between workloads, comprising:
an edge component configured to:
intercept a request from a client workload to access a service workload; and
inject an access credential into the request and forward the request to the service workload; and
a cloud component configured to:
receive, from the edge component, an attestation token comprising identifying information associated with a compute environment in which the client workload executes;
authenticate an identity of the client workload based at least in part on the identifying information;
retrieve, based at least in part on the authenticated client workload identity, an access policy governing access between the client workload and the service workload;
generate or retrieve the access credential for accessing the service workload based at least in part on the access policy; and
provide the access credential to the edge component for injection into the request.
